(19) United States
(12) Patent Application Publication
(10) Pub. No.: US 2021/0105774 A1
(43) Pub. Date: Apr. 8, 2021

(54) METHOD AND APPARATUS FOR ALLOCATING FREQUENCY RESOURCE IN WIRELESS COMMUNICATION SYSTEM

(71) Applicant: Samsung Electronics Co., Ltd., Suwon-si (KR)

(72) Inventors: Jinyoung OH, Suwon-si (KR); Sungjin PARK, Suwon-si (KR); Jonghyun BANG, Suwon-si (KR); Cheolkyu SHIN, Suwon-si (KR)

(21) Appl. No.: 17/036,514

(22) Filed: Sep. 29, 2020

(30) Foreign Application Priority Data
Oct. 2, 2019 (KR) 10-2019-0122658

(51) Int. Cl. H04W 72/04

(52) U.S. Cl. CPC H04W 72/0453

(57) ABSTRACT

A method, performed by a user equipment (UE), in a wireless communication system is provided. The method includes receiving information on a number of physical resource blocks (PRBs), determining a valid number of PRBs based on the information in case that a transform precoding is configured, and transmitting a physical uplink shared channel (PUSCH) based on the valid number of PRBs, wherein in case that the number of PRBs based on the information does not satisfy a pre-defined rule associated with the transform precoding, the valid number of PRBs corresponds to the largest integer satisfying the pre-defined rule associated with the transform precoding which is not greater than the number of PRBs based on the information.

### CROSS-REFERENCE TO RELATED APPLICATION(S)

This application is based on and claims priority under 35 U.S.C. § 119(a) of a Korean patent application number 10-2019-0122658, filed on Oct. 2, 2019, in the Korean Intellectual Property Office, the disclosure of which is incorporated by reference herein in its entirety.

### BACKGROUND

### 1. Field

The disclosure relates to wireless communication systems. More particularly, the disclosure relates to a method and apparatus for allocating frequency resources for transmission of a signal or data channel in a wireless communication system.

### 2. Description of the Related Art

To meet demand due to ever-increasing wireless data traffic after commercialization of the 4th generation (4G) communication system, there have been efforts to develop an advanced 5th generation (5G) system or pre-5G communication system. For this reason, the 5G or pre-5G communication system is also called a beyond 4th generation (4G) network communication system or post long term evolution (LTE) system. Implementation of the 5G communication system using ultra-frequency millimeter wave (mm Wave) bands, e.g., 60 GHz bands, is considered to achieve higher data rates. To reduce propagation loss of radio waves and to increase a transmission range of radio waves in the ultra-frequency bands, beamforming, massive multiple-input multiple-output (MIMO), full dimensional MIMO (FD-MIMO), array antenna, analog beamforming, and large-scale antenna techniques are under discussion. To improve system networks, technologies for advanced small cells, cloud Radio Access Networks (RANs), ultra-dense networks, device to device (D2D) communication, wireless backhaul, moving networks, cooperative communication, Coordinated Multi-Points (CoMP), reception-end interference cancellation and the like are also being developed in the 5G communication system. In addition, in the 5G system, an advanced coding modulation (ACM), e.g., Hybrid frequency shift keying (FSK) and quadrature amplitude modulation (QAM) Modulation (FQAM), sliding window superposition coding (SWSC), and an advanced access technology, e.g., filter bank multi carrier (FBMC), non-orthogonal multiple access (NOMA), sparse code multiple access (SCMA) are being developed.

In the meantime, the Internet is evolving from a human-centered connectivity network where humans generate and consume information to an Internet of Things (IoT) network where distributed entities or things send, receive and process information without human intervention. Internet of Everything (IoE) technologies combined with IoT, such as big data processing technologies through connection with a cloud server, for example, have also emerged. To implement IoT, various technologies, such as a sensing technology, a wired/wireless communication and network infrastructure, a service interfacing technology, and a security technology are required, and recently, technologies for a sensor network, Machine to Machine (M2M) communication, Machine Type Communication (MTC) for connection between things are being studied. Such an IoT environment may provide intelligent Internet Technology (IT) services that create new values in human life by collecting and analyzing data generated among connected things. IoT may be applied to a variety of areas, such as smart homes, smart buildings, smart cities, smart cars or connected cars, smart grid, health care, smart home appliances and advanced medical services through convergence and combination between existing Information Technologies (IT) and various industrial applications.

In this regard, various attempts to apply the 5G communication system to the IoT network are being made. For example, technologies regarding a sensor network, M2M communication, MTC, etc., are implemented by the 5G communication technologies, such as beamforming, MIMO, array antenna schemes, etc. Even application of a cloud Radio Access Network (cloud RAN) as the aforementioned big data processing technology may be said to be an example of convergence of 5G and IoT technologies.

With the development of the aforementioned technologies and mobile communication systems, it is possible to provide various services, and there is a need for a method to provide the services effectively.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for providing a service effectively in a mobile communication system.

Additional aspects will be set forth in part in the description which follows and, in part, will be apparent from the description, or may be learned by practice of the presented embodiments of the disclosure.

In accordance with an aspect of the disclosure, a method, performed by a user equipment (UE), in a wireless communication system is provided. The method includes receiving information on a number of physical resource blocks (PRBs), determining a valid number of PRBs based on the information in case that a transform precoding is configured, and transmitting a physical uplink shared channel (PUSCH) based on the valid number of PRBs, wherein, in case that the number of PRBs based on the information does not satisfy a pre-defined rule associated with the transform precoding, the valid number of PRBs corresponds to the largest integer satisfying the pre-defined rule associated with the transform precoding which is not greater than the number of PRBs based on the information.

The pre-defined rule associated with the transform precoding may require that the valid number of PRBs corresponding to a form of 2ⁿ¹·3ⁿ²·5ⁿ³.

The information may be obtained from a higher layer signaling or a downlink control information (DCI).

The PUSCH may be transmitted on the valid number of PRBs in sequence from the lowest-indexed PRB amongst the number of PRBs based on the information.

The method may further include determining at least one valid PRBs other PRBs than a PRB at a predetermined position from among the number of PRBs based on the information.

In accordance with another aspect of the disclosure, a UE in a wireless communication system is provided. The UE includes a transceiver, and at least one processor connected with the transceiver and configured to receive information on a number of PRBs, determine a valid number of PRBs based on the information when a transform precoding is configured, and transmit a PUSCH, based on the valid number of PRBs, wherein, in case that the number of PRBs based on the information does not satisfy a pre-defined rule associated with the transform precoding, the valid number of PRBs corresponds to the largest integer satisfying the pre-defined rule associated with the transform precoding which is not greater than the number of PRBs based on the information.

The pre-defined rule associated with the transform precoding may require that the valid number of PRBs corresponding to a form of 2ⁿ¹·3ⁿ²·5ⁿ³.

The information may be obtained from a higher layer signaling or a DCI.

The PUSCH may be transmitted on the valid number of PRBs in sequence from the lowest-indexed PRB amongst the number of PRBs based on the information.

The at least one processor may be further configured to determine at least one valid PRBs other PRBs than a PRB at a predetermined position from among the number of PRBs based on the information.

In accordance with another aspect of the disclosure, a method, performed by a base station, in a wireless communication system is provided. The method includes transmitting information on a number of PRBs, and wherein a valid number of PRBs is determined based on the information, in case that a transform precoding is configured, and receiving a PUSCH based on the valid number of PRBs, wherein, in case that the number of PRBs based on the information does not satisfy a pre-defined rule associated with the transform precoding, the valid number of PRBs corresponds to the largest integer satisfying the pre-defined rule associated with the transform precoding which is not greater than the number of PRBs based on the information.

The pre-defined rule associated with the transform precoding may require that the valid number of PRBs corresponding to a form of 2ⁿ¹·3ⁿ²·5ⁿ³.

The information may be transmitted by a higher layer signaling or a DCI.

The PUSCH may be received on the valid number of PRBs in sequence from the lowest-indexed PRB amongst the number of PRBs based on the information.

At least one valid PRB may be determined other than a PRB at a predetermined position from among the number of PRBs based on the information.

In accordance with another aspect of the disclosure, a base station in a wireless communication system is provided. The base station includes a transceiver, and at least one processor connected with the transceiver and configured to transmit information on a number of PRBs, and wherein a valid number of PRBs is determined based on the information, in case that a transform precoding is configured, and receive a PUSCH, based on the valid number of PRBs, wherein, in case that the number of PRBs based on the information does not satisfy a pre-defined rule associated with the transform precoding, the valid number of PRBs corresponds to the largest integer satisfying the pre-defined rule associated with the transform precoding which is not greater than the number of PRBs based on the information.

The pre-defined rule associated with the transform precoding may require that the valid number of PRBs corresponding to a form of 2ⁿ¹·3ⁿ²·5ⁿ³.

The information may be transmitted by a higher layer signaling or a DCI.

The PUSCH may be received on the valid number of PRBs in sequence from the lowest-indexed PRB amongst the number of PRBs based on the information.

At least one valid PRB may be determined other than a PRB at a predetermined position from among the number of PRBs based on the information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system, according to an embodiment of the disclosure;

FIG. 2 is a block diagram of a base station, according to an embodiment of the disclosure;

FIG. 3 is a block diagram of a terminal, according to an embodiment of the disclosure;

FIG. 4 illustrates a configuration of a communicator of a terminal, according to an embodiment of the disclosure;

FIG. 5 illustrates a radio resource region, according to an embodiment of the disclosure;

FIG. 6 illustrates a bandwidth part (BWP), according to an embodiment of the disclosure;

FIG. 7 is a diagram for describing scheduling and feedback, according to an embodiment of the disclosure;

FIG. 8 illustrates a frequency resource allocation scheme, according to an embodiment of the disclosure;

FIG. 9 illustrates a frequency resource allocation scheme, according to an embodiment of the disclosure;

FIG. 10 is a flowchart illustrating an operation of a base station, according to an embodiment of the disclosure; and

FIG. 11 is a flowchart illustrating an operation of a terminal, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It may be understood that respective blocks and combinations of the blocks in processing flowcharts will be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-usable or computer-readable memories oriented for computers or other programmable data processing equipment, so it is possible to manufacture a product that contains instructions for performing functions described in the block(s) of the flowchart. The computer program instructions may also be loaded on computers or programmable data processing equipment, so it is possible for the instructions to generate a process executed by the computer or the other programmable data processing equipment to provide steps for performing functions described in the block(s) of the flowchart.

Throughout the disclosure, the expression “at least one of a, b or c” indicates only a, only b, only c, both a and b, both a and c, both b and c, all of a, b, and c, or variations thereof

A terminal may include a user equipment (UE), a mobile station (MS), a cellular phone, a smart phone, a computer, or a multimedia system capable of performing a communication function.

In the disclosure, a controller may also be referred to as a processor.

In the disclosure, a layer (or a layer apparatus) may also be referred to as an entity.

Furthermore, each block may represent a part of a module, segment, or code including one or more executable instructions to perform particular logic function(s). It is noted that the functions described in the blocks may occur out of order in alternate embodiments of the disclosure. For example, two successive blocks may be performed substantially at the same time or in reverse order.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a smaller number of components and modules, or further divided into a greater number of components and modules. Moreover, the components and modules may be implemented to execute one or more central processing units (CPUs) in a device or security multimedia card. In embodiments of the disclosure, the module may include one or more processors.

Wireless communication systems are evolving from early systems that provide voice-oriented services to broadband wireless communication systems that provide high data rate and high quality packet data services such as third generation partnership project (3GPP) high speed packet access (HSPA), long term evolution (LTE) or evolved universal terrestrial radio access (E-UTRA), LTE-advanced (LTE-A), 3GPP2 high rate packet data (HRPD), ultra mobile broadband (UMB), and IEEE 802.16e communication standards. Furthermore, for the fifth generation (5G) wireless communication system, communication standards for 5G or new radio (NR) are being developed.

For the 5G communication system, various technologies such as a technology for transmitting uplink signals without code block group (CGB) based retransmission or uplink scheduling (e.g., grant-free uplink transmission) to provide various services and support high data transfer rate will be introduced. As such, in a wireless communication system including 5G, at least one of an enhanced mobile broadband (eMBB), massive machine type communications (mMTC), or ultra-reliable and low-latency communications (URLLC) service may be provided for the terminal. The aforementioned services may be provided to the same terminal during the same time interval. In an embodiment of the disclosure, the eMBB may be a service for high rate transmission of high volume data, the mMTC may be a service for least power consumption at the terminal and access of multiple terminals, and the URLLC may be a service for high reliability and low latency, without being limited thereto. These three types of services may be major scenarios in an LTE system or a beyond LTE system such as 5G/NR, but are not limited thereto. The services of the 5G system are examples, and available services in the 5G system are not limited thereto. A system for providing the URLLC service may be referred to as a URLLC system, and a system for providing the eMBB service may be referred to as an eMBB system. The terms service and system may be interchangeably used.

In the following description, a base station (BS) is an entity for performing resource allocation for a terminal, and may include at least one of an eNB, a Node B, gNB, a radio access unit, a base station controller, or a network node. A terminal may include at least one of a UE, an MS, a cellular phone, a smart phone, a computer, or a multimedia system capable of performing a communication function. Herein, a downlink (DL) refers to a radio transmission path for a signal transmitted from a BS to a terminal, and an uplink (UL) refers to a radio transmission path for a signal transmitted from a terminal to a BS. In describing a method and apparatus proposed in the disclosure, the terms physical channel and signal in the LTE or LTE-A system, the 5G system, or the NR system of the related art may be used. In general, a physical channel may be used in delivering information (e.g., downlink/uplink shared channel) of a layer higher than the physical channel and a signal may refer to a signal (e.g., a reference signal) transmitted or received in the physical layer without delivering information to a higher layer. However, in the disclosure, the physical channel and the signal may be interchangeably used, which may be distinguished or determined by those of ordinary skill in the art.

Embodiments of the disclosure will also be applied to other communication systems with similar technical backgrounds or channel types to the mobile communication system as will be described in the disclosure. Accordingly, embodiments of the disclosure will also be applied to other communication systems through some modifications to an extent that does not significantly deviate from the scope of the disclosure when judged by those of ordinary skill in the art.

As a representative example of such a broadband wireless communication system, the 5G or NR system adopts Orthogonal Frequency Division Multiplexing (OFDM) for downlink (DL) and both the OFDM and Single Carrier Frequency Division Multiple Access (SC-FDMA) or discrete Fourier transform (DFT) spread OFDM (DFT-s-OFDM) for uplink (UL). Such a multiple access scheme allocates and operates time-frequency resources for carrying data or control information for respective users not to overlap each other, i.e., to maintain orthogonality, thereby differentiating each user's data or control information.

The NR system adopts a Hybrid Automatic Repeat request (HARQ) scheme that retransmits corresponding data at the physical layer in case decoding fails at the initial stage of transmission. By the HARQ scheme, when a receiver fails to correctly decode data, the receiver transmits information indicating the decoding failure (i.e., NACK; Negative Acknowledgment) to a transmitter so that the transmitter may retransmit the corresponding data at the physical layer. The receiver may increase data reception capability by combining the data retransmitted by the transmitter with the data for which decoding has failed. Further, by the HARQ scheme, when the receiver correctly decodes data, the receiver may transmit information indicating that decoding succeeds (i.e., ACK; Acknowledgment) to the transmitter so that the transmitter may transmit new data.

In the following description, the terms referring to a signal, a channel, control information, network entities, components of an apparatus, etc., are mentioned for convenience of explanation. The disclosure is not limited to the terms as will be used in the following description, and may use different terms having the same meaning in a technological sense.

Furthermore, various embodiments of the disclosure may be described with the terms used in some communication standards (e.g., 3GPP), but the terms are merely examples for explanation. Various embodiments of the disclosure may also be applied with simple modifications to other communication systems.

Various embodiment of the disclosure will be described based on an NR system, but are not limited thereto and may be applied to various wireless communication systems such as LTE, LTE-A, LTE-A-Pro, 5G, etc. Moreover, the disclosure will be described based on the assumption of a system and apparatus for transmitting or receiving signals using an unlicensed band, but may also be applied to a system operating in a licensed band.

In the disclosure, higher layer signaling or higher signal transmission may be a method of delivering a signal to a terminal from a BS using a DL data channel of a physical layer or to a BS from a terminal using an UL data channel of a physical layer, and may include at least one of radio resource control (RRC) signaling, packet data convergence protocol (PDCP) signaling, or a signal delivery method on a media access control (MAC) control element (CE) (MAC CE). Furthermore, the higher layer signaling or the higher signal may include system information transmitted in common to a plurality of terminals, e.g., system information blocks (SIBs), and also include all information delivered by using a physical broadcast channel (PBCH) except a master information block (MIB). Alternatively, the MIB may also be included in the higher signal.

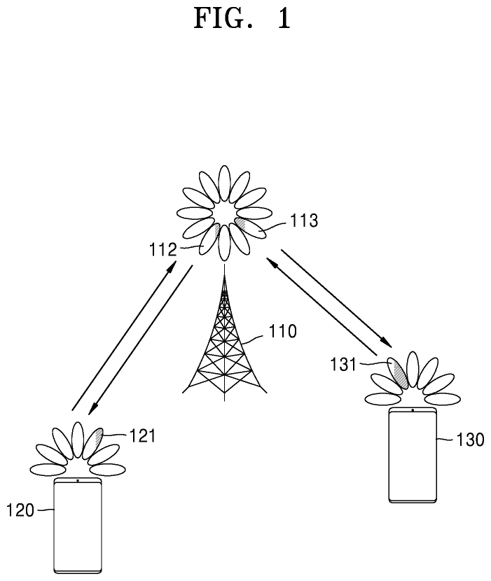

FIG. 1 illustrates a wireless communication system, according to an embodiment of the disclosure.

Referring to FIG. 1, a wireless communication system may be part of nodes using a radio channel, and may include a BS 110, a terminal 120, and a terminal 130. Although there is one BS shown in FIG. 1, another BS (not shown), which is identical or similar to the BS 110, may be further included.

The BS 110 is a network infrastructure that provides wireless access to the terminals 120 and 130. The BS 110 has coverage defined to be a certain geographical area based on a range within which a signal may be transmitted from the BS 110. The BS 110 may also be referred to as an access point (AP), an evolved Node B (eNB), a next generation NodeB or gNodeB (gNB), a 5G node, a wireless point, a transmission/reception point (TRP), or other terms having equal technical meaning

Each of the terminals 120 and 130 is a device used by a user, which performs communication with the BS 110 by using a radio channel In some cases, at least one of the terminal 120 or the terminal 130 may be operated without intervention of the user. For example, at least one of the terminal 120 or the terminal 130 is a device for performing machine type communication (MTC), which may not be carried by the user. Each of the terminals 120 and 130 may also be referred to as a UE, an MS, a subscriber station, a remote terminal, a wireless terminal, a user device, or other terms having equal technical meaning

The wireless communication system 100 may involve wireless communication in an unlicensed band. The BS 110, the terminal 120, and the terminal 130 may transmit or receive wireless signals in an unlicensed band (e.g., 5 to 7 GHz or 64 to 71 GHz). In the unlicensed band, a cellular communication system and another communication system (e.g., a wireless local area network (WLAN)) may coexist. To guarantee fairness between the two communication systems, i.e., to avoid a situation in which a channel is exclusively used by one of the systems, the BS 110, the terminal 120, and the terminal 130 may perform a channel access procedure for the unlicensed band. As an example of the channel access procedure for the unlicensed band, the BS 110, the terminal 120, and the terminal 130 may perform listen before talk (LBT).

The BS 110, the terminal 120, and the terminal 130 may transmit or receive wireless signals in an mmWave band (e.g., 28 GHz, 30 GHz, 38 GHz, or 60 GHz). In this case, to increase channel gains, the BS 110, the terminal 120, and the terminal 130 may perform beamforming. Herein, the beamforming may include transmit beamforming and receive beamforming That is, the BS 110, the terminal 120, and the terminal 130 may give directivity to a signal to be transmitted or received. For this, the BS 110 and the terminals 120 and 130 may select serving beams 112, 113, 121, and 131 through a beam search or beam management procedure. Communication after the serving beams 112, 113, 121, and 131 are selected may be performed with resources quasi co-located (QCL) with resources in which the serving beams 112, 113, 121, and 131 have been transmitted. The BS 110 may transmit or receive signals to or from terminal 120 using a serving beam 112, and the terminal 120 may transmit or receive to or from the BS 110 using a serving beam 121. Similarly, the BS 110 may transmit or receive signals to or from terminal 130 using a serving beam 113, and the terminal 130 may transmit or receive to or from the BS 110 using a serving beam 131.

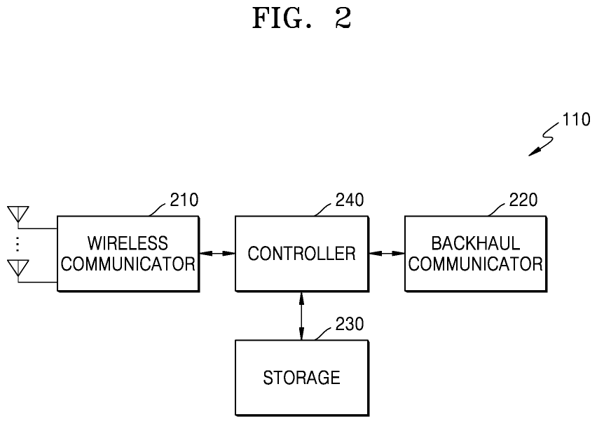

FIG. 2 is a block diagram of a BS, according to an embodiment of the disclosure.

A configuration illustrated in FIG. 2 may be understood as a configuration of the BS 110 of FIG. 1. “Unit,” “module,” “block,” etc. used herein each represent a unit for handling at least one function or operation, and may be implemented in hardware, software, or a combination thereof

Referring to FIG. 2, the BS may include a wireless communicator 210, a backhaul communicator 220, a storage 230, and a controller 240.

The wireless communicator 210 (which may be interchangeably used with a transceiver) performs functions for transmitting or receiving signals by using a radio channel. For example, the wireless communicator 210 performs a conversion function between a baseband signal and a bitstream according to a physical layer standard of the system. For example, for data transmission, the wireless communicator 210 may generate complex symbols by encoding and modulating a bitstream for transmission. For data reception, the wireless communicator 210 reconstructs a received bitstream by demodulation and decoding of the baseband signal.

Furthermore, the wireless communicator 210 performs up-conversion on the baseband signal to a radio frequency (RF) band signal and transmits the resultant signal through an antenna, and performs down-conversion on an RF band signal received through an antenna to a baseband signal. For this, the wireless communicator 210 may include a transmit filter, a receive filter, an amplifier, a mixer, an oscillator, a digital to analog converter (DAC), an analog to digital converter (ADC), etc. The wireless communicator 210 may also include a number of transmission and reception paths. Furthermore, the wireless communicator 210 may include at least one antenna array comprised of multiple antenna elements.

From a perspective of hardware, the wireless communicator 210 may include a digital unit and an analog unit, and the analog unit may include multiple sub-units depending on operation power, operating frequency, etc. The digital unit may be implemented with at least one processor (e.g., a digital signal processor (DSP)).

The wireless communicator 210 transmits or receives a signal as described above. All or part of the wireless communicator 210 may be referred to as a transmitter, a receiver, or a transceiver. In the following description, transmission or reception performed by using a radio channel is used as having the meaning that the aforementioned processes are performed by the wireless communicator 210. In an embodiment of the disclosure, the wireless communicator 210 may include at least one transceiver.

The backhaul communicator 220 may provide an interface for communicating with other nodes in the network. Specifically, the backhaul communicator 220 may convert a bitstream to be transmitted from the BS to another node, e.g., another access node, another BS, a higher node, a core network, etc., into a physical signal, and convert a physical signal received from another node into a bitstream.

The storage 230 may store a basic program for operation of the BS, an application program, data such as configuration information. The storage 230 may include a volatile memory, a non-volatile memory, or a combination of the volatile memory and the non-volatile memory. The storage 230 may provide data stored therein at the request of the controller 240. In an embodiment, the storage 230 may include a memory.

The controller 240 may control general operations of the BS. For example, the controller 240 may transmit or receive a signal through the wireless communicator 210 or the backhaul communicator 220. The controller 240 may also record or read data onto or from the storage 230. The controller 240 may further perform functions of a protocol stack requested by a communication standard. In another implementation, the protocol stack may be included in the wireless communicator 210. In an embodiment of the disclosure, the controller 240 may include at least one processor.

In various embodiments of the disclosure, the controller 240 may control the BS to operate according to various embodiments of the disclosure, which will be described later. For example, the controller 240 may perform a channel access procedure for a non-licensed band. For example, a transceiver (e.g., the wireless communicator 210) may receive signals transmitted in the non-licensed band, and the controller 240 may determine whether the non-licensed band is in an idle state by comparing a strength of the received signal with a threshold or a value of a function defined in advance or having a factor such as bandwidth. Furthermore, for example, the controller 240 may transmit a control signal to a terminal or receive a control signal from a terminal through the transceiver. Moreover, the controller 240 may transmit data to a terminal or receive data from a terminal through the transceiver. The controller 240 may determine a transmission result of a signal transmitted to the terminal, based on a control signal, a control channel, or a data channel received from the terminal.

Furthermore, for example, the controller 240 may maintain or change a contention window (hereinafter, adjust a contention window) for a channel access procedure, based on the transmission result, i.e., a reception result of the control signal, control channel, or data channel at the terminal. In various embodiments of the disclosure, the controller 240 may determine a reference slot for obtaining the transmission result for the contention window adjustment. The controller 240 may determine a data channel for the contention window adjustment in the reference slot. The controller 240 may determine a data channel for the contention window adjustment in a reference slot. When an unlicensed band is determined to be in an idle state, the controller 240 may occupy the channel.

Furthermore, in the disclosure, the controller 240 may control the wireless communicator 210 to receive UL data from the terminal, and determine whether retransmission of one or more CBGs included in the UL data is required. Moreover, the controller 240 may generate DL control information to schedule retransmission of a CBG required for retransmission and/or initial transmission of UL data, and control the wireless communicator 210 to transmit the DL control information to the terminal. In this regard, information indicating whether to retransmit the CBG may be generated as will be described in the disclosure. Furthermore, the controller 240 may control the wireless communicator 210 to receive UL data (re)transmitted according to the DL control information.

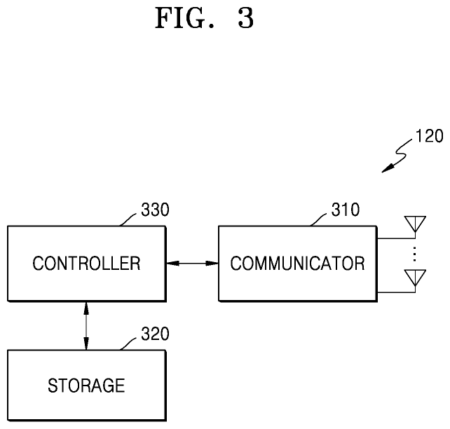

FIG. 3 is a block diagram of a terminal in a wireless communication system, according to an embodiment of the disclosure.

A configuration illustrated in FIG. 3 may be understood as a configuration of the terminal 130 or 120 of FIG. 1. The terms “unit,” “module,” “block,” etc., used herein each represent a unit for handling at least one function or operation, and may be implemented in hardware, software, or a combination thereof

Referring to FIG. 3, a terminal includes a communicator 310, a storage 320, and a controller (or processor) 330.

The communicator 310 (which term may be interchangeably used with a transceiver) performs functions for transmitting or receiving signals by using a radio channel For example, the communicator 310 performs a conversion function between a baseband signal and a bitstream according to a physical layer standard of the system. For example, for data transmission, the communicator 310 may generate complex symbols by encoding and modulating a bitstream for transmission. For data reception, the communicator 310 reconstructs a received bitstream by demodulation and decoding of the baseband signal. Furthermore, the communicator 310 performs up-conversion on the baseband signal to an RF band signal and transmits the resultant signal through an antenna, and performs down-conversion on an RF band signal received through the antenna to a baseband signal. For example, the communicator 310 may include a transmit filter, a receive filter, an amplifier, a mixer, an oscillator, a DAC, an ADC, etc.

The communicator 310 may also include a number of transmission and reception paths. Furthermore, the communicator 310 may include at least one antenna array comprised of multiple antenna elements. From the perspective of hardware, the communicator 310 may be comprised of a digital circuit and an analog circuit (e.g., a radio frequency integrated circuit (RFIC)). In this case, the digital circuit and the analog circuit may be implemented in a single package. The communicator 310 may include multiple RF chains. Furthermore, the communicator 310 may perform beamforming

The communicator 310 transmits or receives a signal as described above. All or part of the communicator 310 may be referred to as a transmitter, a receiver, or a transceiver. In the following description, transmission or reception performed by using a radio channel is used as having meaning that the aforementioned processes are performed by the communicator 310. In an embodiment of the disclosure, the communicator 310 may include at least one transceiver.

The storage 320 may store a basic program for operation of the terminal, an application program, and data such as configuration information. The storage 320 may include a volatile memory, a non-volatile memory, or a combination of the volatile memory and the non-volatile memory. The storage 320 may provide data stored therein at the request of the controller 330. In an embodiment, the storage 320 may include a memory.

The controller 330 may control general operations of the terminal. For example, the controller 330 may transmit or receive a signal through the communicator 310. The controller 330 may also record or read data onto or from the storage 320. The controller 330 may further perform functions of a protocol stack requested by a communication standard. For this, the controller 330 may include at least one processor or microprocessor, or may be a portion of a processor. In an embodiment of the disclosure, the controller 330 may include at least one processor. Furthermore, in an embodiment of the disclosure, a portion of the communicator 310 and/or the controller 330 may be referred to as a communication processor (CP).

In various embodiments of the disclosure, the controller 330 may control the terminal to operate according to various embodiments of the disclosure, which will be described later. For example, the controller 330 may receive a DL signal (a DL control signal or DL data) transmitted by the BS through the transceiver (e.g., the communicator 310). Furthermore, for example, the controller 330 may determine a transmission result of the DL signal. The transmission result may include feedback information such as ACK, NACK, discontinuous transmission (DTX), etc., of the transmitted DL signal. In the disclosure, the transmission result may be called by various terms such as a reception state, reception result, decoding result, HARQ-ACK information, etc., of the DL signal. Furthermore, for example, the controller 330 may transmit a UL signal to the BS through the transceiver in response to a DL signal. The UL signal may explicitly or implicitly include the transmission result of the DL signal.

The controller 330 may perform a channel access procedure for a non-licensed band. For example, a transceiver (e.g., the communicator 310) may receive signals transmitted in the non-licensed band, and the controller 330 may determine whether the non-licensed band is in an idle state by comparing strength of the received signal with a threshold or a value of a function defined in advance or having a factor such as bandwidth. The controller 330 may perform an access procedure for the unlicensed band to transmit a signal to the BS.

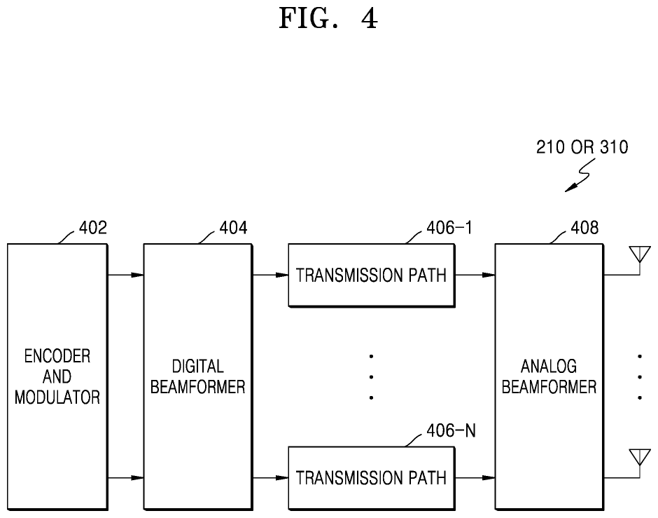

FIG. 4 is a block diagram of a communicator in a wireless communication system, according to an embodiment of the disclosure.

In FIG. 4, an example of a detailed configuration of the wireless communicator 210 of FIG. 2 or the communicator 310 of FIG. 3 is illustrated. Specifically, components, which are parts of the wireless communicator 210 of FIG. 2 or the communicator 310 of FIG. 3, involved in performing beamforming are illustrated in FIG. 4.

Referring to FIG. 4, the wireless communicator 210 or the communicator 310 may include an encoder and modulator 402, a digital beamformer 404, multiple transmission paths 406-1 to 406-N, and an analog beamformer 408.

The encoder and modulator 402 may perform channel encoding. For channel encoding, at least one of low density parity check (LDPC) codes, convolution codes, or polar codes may be used. The encoder and modulator 402 may generate modulated symbols by performing constellation mapping.

The digital beamformer 404 may perform beamforming on a digital signal (e.g., modulated symbols). For this, the digital beamformer 404 may multiply the modulated symbols by beamforming weights. The beamforming weights may be used to change the magnitude and phase of a signal, and be referred to as a precoding matrix, a precoder, etc. The digital beamformer 404 may output digitally beamformed modulated symbols on the multiple transmission paths 406-1 to 406-N. In this case, according to a multiple input multiple output (MIMO) transmission scheme, the modulated symbols may be multiplexed or the same modulated symbols may be provided on the multiple transmission paths 406-1 to 406-N.

The multiple transmission paths 406-1 to 406-N may convert digitally beamformed digital signals to analog signals. For this, the multiple transmission paths 406-1 to 406-N may each include an inverse fast Fourier transform (IFFT) operator, a cyclic prefix (CP) inserter, a digital-to-analog converter (DAC), and an up-converter. The CP inserter is for an OFDM scheme, and may be omitted when a different physical layer scheme (e.g., a filter bank multi-carrier (FBMC) scheme) is applied. In other words, the multiple transmission paths 406-1 to 406-N provide independent signal processing processes on multiple streams generated through digital beamforming However, depending on implementation methods, some of the components of the multiple transmission paths 406-1 to 406-N may be shared.

The analog beamformer 408 may perform beamforming on an analog signal. For this, the analog beamformer 408 may multiply analog signals by beamforming weights. The beamforming weights may be used to change magnitude and phases of the signal. Specifically, depending on a coupling structure between the multiple transmission paths 406-1 to 406-N and antennas, the analog beamformer 408 may be variously configured. For example, each of the multiple transmission paths 406-1 to 406-N may be connected to an antenna array. For example, the multiple transmission paths 406-1 to 406-N may be connected to an antenna array. In another example, the multiple transmission paths 406-1 to 406-N may be adaptively connected to one, two, or more antenna arrays.

In a 5G system, considering various services and requirements, a frame structure for the 5G system needs to be flexibly defined. For example, each service may have a different subcarrier spacing (SCS) depending on a requirement. Modern 5G communication systems may support a plurality of SCSs, and an SCS may be determined in the following Equation 1:

Δf=f₀2′″ Equation 1

In the Equation 1, f₀ indicates a default SCS of the system, m indicates a scaling factor of integers, and Δf indicates an SCS. For example, assuming that f₀ is 15 kHz, a set of SCSs that the 5G communication system is able to have may be comprised of one of 3.75 kHz, 7.5 kHz, 15 kHz, 30 kHz, 60 kHz, 120 kHz, 240 kHz, and 480 kHz. An available SCS set may differ by the frequency band. For example, for frequency bands at or under 7 GHz, at least one SCS of 3.75 kHz, 7.5 kHz, 15 kHz, 30 kHz, or 60 kHz may be used, and for frequency bands above 7GHz, at least one SCS of 60 kHz, 120 kHz, 240 kHz or more may be used.

In various embodiments of the disclosure, depending on the SCS that makes up an OFDM symbol, length of the OFDM symbol may be changed. This is because the properties of the OFDM symbol, the SCS and the length of the OFDM symbol have a reciprocal relation to each other. For example, when the SCS is doubled, the symbol length is reduced in half, and when the SCS is reduced in half, the symbol length is doubled.

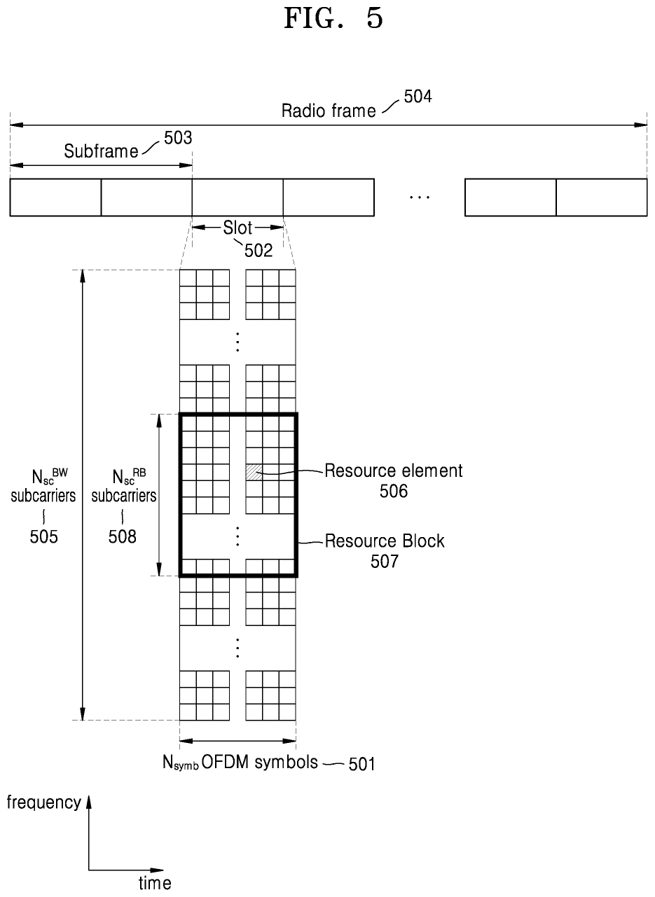

FIG. 5 illustrates a radio resource region, according to an embodiment of the disclosure.

In various embodiments of the disclosure, a radio resource region may have a structure of the time-frequency domain. In various embodiments, the wireless communication system may include an NR communication system.

Referring to FIG. 5, in the radio resource region, the horizontal axis represents the time domain, and the vertical axis represents the frequency domain. A minimum transmission unit in the time domain may be an OFDM and/or DFT-s-OFDM symbol, and a number N_{symb} of OFDM and/or DFT-s-OFDM symbols 501 may make up a slot 502. In various embodiments of the disclosure, the OFDM symbol may include a symbol for a case of transmitting or receiving a signal using an OFDM multiplexing scheme, and the DFT-s-OFDM symbol may include a symbol for a case of transmitting or receiving a signal using a single carrier frequency division multiple access (SC-FDMA) multiplexing scheme. An embodiment of the disclosure based on the OFDM symbol will now be described for convenience of explanation, but it is noted that a DFT-s-OFDM symbol based embodiment of the disclosure may also be applied. Furthermore, an embodiment of the disclosure for DL signal transmission or reception will be described for convenience of explanation, but another embodiment of the disclosure for UL signal transmission or reception will also be applied.

When the SCS is 15 kHz, unlike what is shown in FIG. 5, the one slot 502 makes up a subframe 503, and the slot 502 and the subframe 503 may each be 1 ms long. In various embodiments of the disclosure, the number of slots making up the one subframe 503 and the slot length may be different depending on the SCS. For example, when the SCS is 30 kHz, two slots may make up the one subframe 503 as shown in FIG. 5. In this case, the slot is 0.5 ms long, and the subframe 503 is 1 ms long. The radio frame 504 may be a time domain interval made up with 10 subframes. A minimum transmission unit in the frequency domain is a subcarrier, and carrier bandwidth that makes up resource grid may be comprised of a total of subcarriers 505.

The SCS, the number of slots 502 included in the subframe 503, the length of the slot 502, however, may be variably applied. For example, for an LTE system, the SCS is 15 kHz and two slots make up the one subframe 503, in which case the slot 502 may be 0.5 ms long and the subframe 503 may be 1 ms long. In another example, for an NR system, the SCS (μ)may be one of 15 kHz, 30 kHz, 60 kHz, 120 kHz, and 240 kHz, and the number of slots included in a subframe may be 1, 2, 4, 8, or 16 depending on the SCS (μ)

In the time-frequency domain, a default resource unit may be a resource element (RE) 506, and the RE 506 may be represented with an OFDM symbol index and a subcarrier index. A resource block 507 may include a plurality of REs. In an LTE system, the resource block (RB) or physical resource block (PRB) 507 may be defined by a number N_{symb} of consecutive OFDM symbols 501 in the time domain and a number N_{SC}^{RB} of consecutive subcarriers 508 in the frequency domain. The number of symbols included in one RB may be N_{symb}=14, and the number of subcarriers may be N_{SC}^{RB}=12, or the number of symbols included in one RB may be N_{symb}=7 and the number of subcarriers may be N_{SC}^{RB}=12. The number of RBs may vary depending on bandwidth of the system transmission band.

In an NR system, the RB 507 may be defined by N_{SC}^{RB} consecutive subcarriers in the frequency domain. The number of subcarriers may be N_{SC}^{RB}=12. The frequency domain may include common resource blocks (CRBs), and a PRB may be defined in a bandwidth part (BWP) in the frequency domain. Different CRB and PRB numbers may be determined depending on the SCS.

DL control information may be transmitted in first N OFDM symbols in a slot. In general, N may be N={1, 2, 3}, and the terminal may be configured with the number of symbols in which DL control information may be transmitted from the BS through higher layer signaling. Furthermore, depending on an amount of control information to be transmitted in a current slot, the BS may change the number of symbols in which the DL control information may be transmitted for each slot, and transmit information about the number of symbols to the terminal by using a separate DL control channel

In the NR and/or LTE system, scheduling information for DL data or UL data is transmitted through downlink control information (DCI) from the BS to the terminal In various embodiments of the disclosure, the DCI may be defined in various formats, each format being changed according to whether the DCI includes scheduling information for UL data (UL grant) or scheduling information for DL data (DL grant), whether the DCI corresponds to compact DCI with a small size of control information or fall-back DCI, whether spatial multiplexing with multiple antennas is applied, and/or whether the DCI corresponds to DCI for power control.

For example, a DCI format (e.g., DCI format 1_0 of NR) corresponding to scheduling control information (DL grant) for DL data may include at least one of the following pieces of control information:
DCI format identifier: an identifier for identifying a format of the DCI
frequency domain resource allocation: indicates an RB allocated for data transmission
time domain resource allocation: indicates slots and symbols allocated for data transmission
virtual resource block (VRB)-to-PRB mapping: indicates whether to apply a VRB mapping scheme
Modulation and coding scheme (MCS): indicates the size of a transport block (TB) that is data to be transmitted and modulation scheme used for data transmission
New data indicator (NDI): indicates whether it is HARQ initial transmission or retransmission
Redundancy version (RV): indicates a redundancy version of HARQ.
HARQ process number: indicates a process number of HARQ.
Physical downlink shared channel (PDSCH) assignment index (or downlink assignment index): indicates the number of PDSCH reception results to be reported from the UE to the BS (e.g., the number of HARQ-ACKs)
Transmit Power Control (TPC) command for Physical Uplink Control Channel (PUCCH): indicates transmit power control command for an uplink control channel, PUCCH
PUCCH resource indicator: indicates a PUCCH resource used in reporting HARQ-ACK that includes a reception result of a PDSCH configured through the DCI
PUCCH transmit timing indicator (or PDSCH-to-HARQ_feedback timing indicator): indicates information about a slot or a symbol in which to transmit a PUCCH for reporting HARQ-ACK including a reception result of a PDSCH configured through the DCI

The DCI may be transmitted on a physical downlink control channel (PDCCH) or an enhanced PDCCH (EPDCCH) after going through channel coding and modulation processes. Hereinafter, transmission or reception on a PDCCH or EPDCCH may be understood as DCI transmission or reception on the PDCCH or EPDCCH, and transmission or reception on a PDSCH may be understood as DL data transmission or reception on the PDSCH.

In various embodiments of the disclosure, a cyclic redundancy check (CRC) scrambled by a particular radio network temporary identifier (RNTI) or a cell RNTI (C-RNTI) that is independent for each terminal, may be added to the DCI. Furthermore, DCI for each terminal may go through channel coding, and may be configured into an independent PDCCH and transmitted. In the time domain, the PDCCH may be transmitted during a control channel transmission interval. In the frequency domain, a mapping position of the PDCCH may be determined by at least an identifier (ID) of each terminal, and may be transmitted in the entire system transmission band or a set frequency band of the system transmission band. Alternatively, in the frequency domain, a mapping position of the PDCCH may be configured by higher layer signaling.

DL data may be transmitted on a PDSCH, which is a physical channel for DL data transmission. The PDSCH may be transmitted after a control channel transmission interval, and in the frequency region, scheduling information such as a mapping position of the PDSCH and a modulation scheme for the PDSCH may be determined based on DCI transmitted by using a PDCCH.

Through modulation and coding scheme (MCS) information among the control information making up the DCI, the base station may notify the terminal of a modulation scheme applied to the PDSCH to be transmitted and the size of data to be transmitted (transport block size; TBS). In various embodiments of the disclosure, an MCS may be comprised of 5 bits or more than or less than 5 bits. The TBS corresponds to the size of a TB before channel coding for error correction is applied to the data (TB) to be transmitted by the BS.

In an NR system, a modulation scheme supported for UL and DL data transmission may include at least one of quadrature phase shift keying (QPSK), 16 quadrature amplitude modulation (16 QAM), 64 QAM, or 256 QAM, and each modulation order Qₘ may be 2, 4, 6, or 8. For example, two bits per symbol may be transmitted for QPSK modulation, 4 bits per symbol for 16 QAM modulation, 6 bits per symbol for 64 QAM modulation, and 8 bits per symbol for 256 QAM modulation. Furthermore, a modulation scheme above 256 QAM may be used according to a system modification.

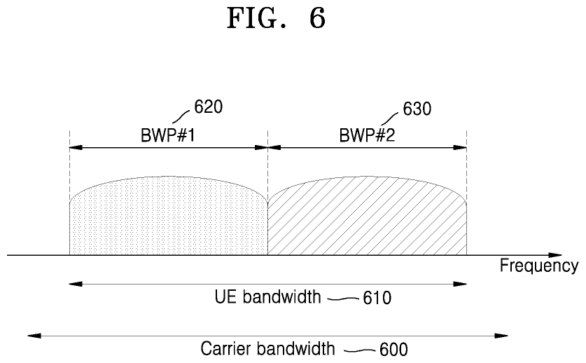

FIG. 6 illustrates a BWP, according to an embodiment of the disclosure.

A BS may configure one or more BWPs for a terminal, in which case the size of each BWP may be equal to or smaller than bandwidth of a carrier or cell.

Referring to FIG. 6, terminal bandwidth (or UE bandwidth) 610 is configured with two BWPs, BWP #1 620 and BWP #2 630. The terminal may be configured with various parameters related to the BWP such as a BWP ID, a BWP frequency location, an SCS, CP, etc., in a higher signal from the BS. The above information may be transmitted by the BS to the UE through higher layer signaling, e.g., RRC signaling.

At least one of one or more BWPs configured for the terminal may be activated at a particular point in time, and the activated BWP may be changed. Whether to activate and/or change a configured BWP may be notified from the BS to the terminal semi-statically through RRC signaling or dynamically through a medium access control (MAC) control element (CE) (MAC CE) or DCI.

Even when the terminal bandwidth 610 supported by the terminal is smaller than system bandwidth or carrier bandwidth 600, the terminal may transmit or receive data to or from the BS at a particular frequency location in the system bandwidth 600. In addition, different SCSs may be supported in the BS or cell. For example, to support data transmission and reception using both 15 KHz subcarrier spacing and 30 KHz subcarrier spacing for a terminal, two BWPs may be configured to use 15 KHz and 30 KHz subcarrier spacings, respectively. The different BWPs may be frequency division multiplexed, and for data transmission and reception with a particular SCS, a BWP configured with the SCS may be changed or activated. In another example, the BS may configure a BWP in a narrow band and a BWP in a wide band for the terminal for the purpose of reducing power consumption of the terminal, minimize power consumption of the terminal by activating the BWP in the narrow band of the terminal in a situation where there is no traffic, and transmit or receive data at a higher data transmission rate by changing or activating an activated BWP of the terminal to the BWP in the wide band when data occurs.

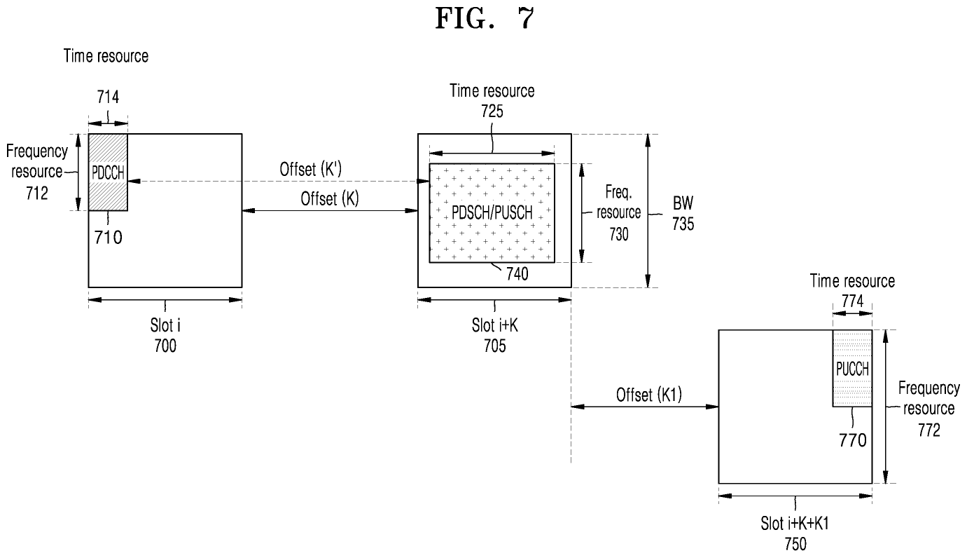

FIG. 7 is a diagram for describing scheduling and feedback, according to an embodiment of the disclosure.

Referring to FIG. 7, the BS may transmit control information that includes scheduling information for a DL and/or UL data channel to the terminal The BS may transmit DL data to the terminal according to the scheduling information. Upon reception of the data, the terminal may transmit HARQ-ACK information, which is feedback for the DL data, to the BS. Or, the terminal may transmit UL data to the BS according to the scheduling information. Upon reception of the data, the BS may transmit HARQ-ACK information, which is feedback for the UL data, to the terminal The feedback may be determined by the terminal through NDI of the scheduling information for the UL data channel or a new data indicator value.

In an NR system, a UL and DL HARQ scheme may include an asynchronous HARQ scheme with no data retransmission time fixed. For example, for DL, when the BS is fed back with NACK as a result of the terminal receiving DL data transmitted by the BS, the BS may freely determine a time to retransmit the DL data according to a BS scheduling operation. Upon reception of DL data retransmission scheduling from the BS, the terminal may buffer data determined to be an error as a result of decoding the received data for HARQ operation with previously received DL data, and then perform combining with retransmitted data from the BS. The BS may be the BS 110 of FIG. 1, and the terminal may be the terminal 120 or 130 of FIG. 1.

Referring to FIG. 7, a resource region in which a data channel is transmitted in a 5G or NR communication system is illustrated. The terminal may monitor and/or search a PDCCH 710 in a DL control channel (hereinafter, a PDCCH) region (hereinafter, control resource set (CORESET)) or search space (SS) configured by the BS through a higher signal. In this case, the DL control channel region includes a time domain including a time resource 714 and a frequency domain including a frequency resource 712. The time resource 714 may be configured in symbols, and the frequency resource 712 may be configured in RBs or RB groups.

When the terminal detects the PDCCH 710 in slot i 700, the terminal may obtain DCI transmitted by using the detected PDCCH 710. Through the received DCI, the terminal may obtain scheduling information for DL data channel or UL data channel 740. In other words, the DCI may include time-frequency resource region (or PDSCH transmission region) information for the UE to receive a DL data channel (hereinafter, a PDSCH) transmitted from the BS, or time-frequency resource region information allocated from the BS to the terminal for UL data channel (PUSCH) transmission.

An example of an occasion when the terminal is scheduled with PUSCH transmission will now be described. Upon reception of the DCI, the terminal may obtain a slot index or offset information K at which to receive a PUSCH transmitted in the DCI, and determine a PUSCH transmission slot index. For example, the terminal may determine as having been scheduled to transmit a PUSCH in slot i+K 705 through the received offset information K based on the slot i 700 in which the PDCCH 710 is received. In this case, the terminal may determine the slot i+K 705 or a symbol or time to start the PUSCH in the slot i+K 705 through the received offset information K based on a CORESET in which the PDCCH 710 has been received.

The terminal may also obtain information about the PUSCH transmission time-frequency resource region 740 in the PUSCH transmission slot i+K 705 from the DCI. Information for configuring a PUSCH transmission frequency resource region 730 may include PRB- or PRB group-based information. In the meantime, the Information for configuring the PUSCH transmission frequency resource region 730 may be information about a region included in initial UL bandwidth (BW) 735 or an initial UL BWP determined or configured for the terminal through an initial access procedure. When the terminal is configured with UL BW 735 or a UL BWP through a higher signal, the information for configuring the PUSCH transmission frequency resource region 730 may be information about a region included in the UL BW 735 or the UL BWP configured through the higher signal.

In various embodiments of the disclosure, information for configuring a PUSCH transmission time resource region 725 may be information indicating symbol- or symbol group-based information or absolute time information. The information for configuring the PUSCH transmission time resource region 725 may be represented by a combination of a time or symbol to start PUSCH transmission, PUSCH length, and a time or symbol to terminate the PUSCH, and included as a field or a value in the DCI. The terminal may transmit a PUSCH in the PUSCH transmission resource region 740 determined based on the DCI. In an embodiment of the disclosure, what is described above may also be applied to a DL data channel (PDSCH) that transmits DL data.

In various embodiments of the disclosure, upon reception of the PDSCH 740, the terminal may give feedback with a result of reception of the PDSCH 740 (e.g., HARQ-ACK/NACK) to the BS. In this case, a resource (e.g., a frequency resource 772 and a time resource 774) for transmitting UL control channel (i.e., PUCCH 770) that transmits the result of reception of the PDSCH 740 (i.e., UL control information) may be determined by the terminal based on a PDSCH-to-HARQ timing indicator and a PUCCH resource indicator indicated through the DCI that schedules the PDSCH 740. In other words, the terminal, upon reception of the PDSCH-to-HARQ timing indicator K1, may transmit the PUCCH 770 in slot i+K+K1 750 after K1 from the slot i+K 705 in which the PDSCH 740 is received.

The BS may configure one or more K1 values for the terminal through higher layer signaling, or indicate a particular K1 value to the terminal through DCI as described above. K1 may be determined according to HARQ-ACK processing capability of the terminal, i.e., a minimum time required for the terminal to receive the PDSCH and generate and report HARQ-ACK for the PDSCH. The terminal may also use a predefined value or a default value for the K1 value until configured with a K1 value. In this case, a time for the terminal to transmit the result of reception of the PDSCH (HARQ-ACK) may not be indicated through one of the K1 values or a non-numerical value defined in advance or configured through a higher signal.

Transmission of the PUCCH 770 in the PUCCH transmission slot i+K+K1 750 may be performed in a resource indicated through the PDCCH resource indicator in the DCI. In this case, when a plurality of PUCCH transmissions are configured or indicated in the PUCCH transmission slot i+K+K1 750, the terminal may perform PUCCH transmission in a PUCCH resource other than the resource indicated through the PUCCH resource indicator in the DCI.

In a 5G communication system, to dynamically change DL signal transmission and UL signal transmission intervals in a time division duplex (TDD) system, whether OFDM symbols that make up one slot are each a DL symbol, a UL symbol, or a flexible symbol may be indicated by a slot format indicator (SFI). A symbol indicated as a flexible symbol refers to one which is not either the DL symbol or the UL symbol, or which may be changed to a DL or UL symbol based on terminal-specific control information or scheduling information. The flexible symbol may include a gap guard required in a procedure of being switched from DL to UL.

The slot format indicator may be simultaneously transmitted to multiple terminals by using a terminal group (or cell) common control channel In other words, the slot format indicator may be transmitted by using a PDCCH which is CRC scrambled by a terminal-specific identifier (C-RNTI) and another identifier (e.g., SFI-RNTI). In various embodiments of the disclosure, the slot format indicator may include information about N slots, where N is an integer or a natural number greater than 0, or may be a value set by the BS for the terminal in a higher signal among a set of predefined available values, such as 1, 2, 5, 10, 20, etc. Furthermore, the size of the slot format indicator information may be set by the BS for the UE in a higher signal. An example of slot formats that may be indicated by the slot format indicator may be shown in the following Table 1.

TABLE 1

| | Symbol Number (or index) in One Slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-754 | Reserved |
| 255 | UE determines the slot format for the slot based on TDD-UL-DL- |
| | ConfigurationCommon, or TDD-UL-DL-ConfigDedicated and, if any, |
| | on detected DCI formats |

In Table 1, D means DL, U means UL, and F means a flexible symbol. According to Table 1, a total number of slot formats that may be supported is 256. In the modern NR system, a maximum size of slot format indicator information bits is 128 bits, and the slot format indicator information bits may be set by the BS for the UE in a higher signal (e.g., DCI-PayloadSize). In this case, a cell operating in a licensed band or unlicensed band may configure or indicate an additional slot format as in the following Table 2 using one or more additionally introduced slot formats or at least one modified format among the existing slot formats. Table 2 shows an example of slot formats by which a slot is made up with the uplink U and the flexible symbol F.

TABLE 2

| | Symbol Number (or index) in One Slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 56 | F | U | U | U | U | U | U | U | U | U | U | U | U | U |
| 57 | F | F | U | U | U | U | U | U | U | U | U | U | U | U |
| 58 | U | U | U | U | U | U | U | U | U | U | U | U | U | F |
| 59 | U | U | U | U | U | U | U | U | U | U | U | U | F | F |
| . . . | | | | | | | | | | | | | | |

In various embodiments of the disclosure, the slot format indicator information may include slot formats for a plurality of serving cells, and a slot format for each serving cell may be identified by a serving cell ID. Furthermore, for each serving cell, a combination of slot format indicators for one or more slots (e.g., slot format combination) may be included. For example, when the slot format indicator information is in 3 bits and comprised of a slot format indicator for a serving cell, the 3-bit slot format indicator information may be one of a total of 8 slot format indicators or a slot format indicator combination (hereinafter, a slot format indicator), and the BS may indicate one of the 8 slot format indicators through a terminal group common information, e.g., group common DCI.

In various embodiments of the disclosure, at least one of the 8 slot format indicators may be comprised of slot format indicators for a plurality of slots. For example, an example of 3-bit slot format indicator information comprised of the slot formats in Table 1 and Table 2 is shown in the following Table 3. Five pieces of the slot format indicator information (slot format combination IDs 0, 1, 2, 3, and 4) are about a slot format indicator for a slot, and the other three may be information about slot format indicators for four slots (slot format combination IDs 5, 6, and 7) and may be sequentially applied to the four slots. In this case, the slot format indicator information may be sequentially applied to slots starting from a slot in which the slot format indicator is received.

TABLE 3

| Slot format combination ID | Slot Formats |
|---|---|
| 0 | 0 |
| 1 | 1 |
| 2 | 2 |
| 3 | 19 |
| 4 | 9 |
| 5 | 0 0 0 0 |
| 6 | 1 1 1 1 |
| 7 | 2 2 2 2 |

The terminal may receive configuration information for a PDCCH in which to detect the slot format indicator information through a higher signal, and detect a slot format indicator according to the configuration. For example, the terminal may be configured, through a higher signal, with at least one of a configuration of a CORESET in which to detect the slot format indicator information, a search space configuration, information about an RNTI used in CRC scrambling of the DCI in which the slot format indicator information is transmitted, a cycle of the search space, or offset information.

For a system that performs communication in an unlicensed band, a communication device (a BS or a terminal) that intends to transmit a signal in the unlicensed band may perform a channel access procedure or LBT for the unlicensed band in which to perform communication before transmitting the signal, and access the unlicensed band and perform signal transmission when it is determined that the unlicensed band is in an idle state according to the channel access procedure. When it is determined that the unlicensed band is not in the idle state according to the channel access procedure performed, the communication device may not perform signal transmission.

The channel access procedure in the unlicensed band may be classified by whether a time to start the channel access procedure of the communication device is fixed (frame-based equipment (FBE)) or variable (load-based equipment (LBE)). In addition to the time to start the channel access procedure, depending on whether a transmit/receive structure of the communication device has a cycle or no cycle, the communication device may be determined to be the FBE or the LBE. In this case, the time to start the channel access procedure being fixed means that the channel access procedure of the communication device may be started periodically according to a predefined cycle or a cycle declared or set by the communication device. In another example, the time to start the channel access procedure being fixed may mean that the transmit or receive structure of the communication device has a cycle. On the other hand, the time to start the channel access procedure being variable means that the communication device may transmit a signal in an unlicensed band at any time. In another example, the time to start the channel access procedure being variable may mean that the transmit or receive structure of the communication device may be determined as required without having a cycle.

A channel access procedure in the case that the time to start the channel access procedure of the communication device is variable, i.e., LBE, (hereinafter, traffic based channel access procedure or LBE based channel access procedure) will now be described.

The channel access procedure in an unlicensed band may include measuring strength of a signal received by the communication device in the unlicensed band for a fixed period of time or a period of time calculated according to a predefined rule (e.g., a time calculated with at least a random value selected by the BS or the terminal), and determine an idle state of the unlicensed band by comparing the measured strength of the signal with a predefined threshold or a threshold calculated by a function that determines the magnitude of the strength of the received signal according to at least one attribute among channel bandwidth, bandwidth of a signal for transmission, and/or strength of transmission power.

For example, the communication device may measure the strength of the received signal for a time X μs (e.g., 25 μs) immediately before a point in time to transmit a signal, determine that the unlicensed band is in the idle state and transmit a set signal when the strength of the measured signal is smaller than a threshold T (e.g., −72 dBm) defined or calculated in advance. In this case, after the channel access procedure, a maximum period of time available for continuous signal transmission may be restricted by a maximum channel occupancy time (MCOT) defined for each country, region, or frequency band based on each unlicensed band, and even by a type of the communication device (e.g., a BS or a terminal, or a master device or a slave device). For example, in the 5 GHz unlicensed band for Japan, a BS or a terminal may occupy a channel to transmit a signal without performing an additional channel access procedure for up to 4 ms for an unlicensed band determined to be in the idle state.

Specifically, when the BS or the terminal intends to transmit a DL or UL signal in the unlicensed band, a channel access procedure that may be performed by the BS or the terminal may be identified as at least one of the following types:
type 1: transmitting a UL/DL signal after performing a channel access procedure for a variable period of time
type 2: transmitting a UL/DL signal after performing a channel access procedure for a fixed period of time
type 3: transmitting a DL or UL signal without performing a channel access procedure

A transmitting apparatus (e.g., a BS or a terminal) which intends to perform signal transmission may determine a type of the channel access procedure according to a type of a signal for transmission. In the 3GPP, a channel access scheme, an LBT procedure may be classified largely into four categories. The four categories may include a first category including a scheme that does not perform LBT, a second category including a scheme that performs LBT, a third category including a scheme that performs LBT through random backoff in a fixed sized contention window, and a fourth category including a scheme that performs LBT through random backoff in a variable sized contention window. In an embodiment of the disclosure, the third and fourth categories may be reserved for the type 1, the second category for the type 2, and the first category for the type 3. In this case, the type 2 or the second category that performs a channel access procedure for a fixed period of time may be classified into one or more types according to the fixed period of time for which the channel access procedure is performed. For example, the type 2 may be classified into a type for performing the channel access procedure for a fixed period of time A μs (e.g., 25 μs) and a type for performing the channel access procedure for a fixed period of time B μs (e.g., 16 μs).

In the disclosure, a transmitting apparatus may be assumed to be a BS, and the transmitting apparatus and the BS may be interchangeably used.

For example, when a BS intends to transmit a DL signal including a DL data channel in an unlicensed band, the BS may perform a channel access procedure in a scheme of the type 1. Otherwise, when a BS intends to transmit a DL signal that does not include a DL data channel in an unlicensed band, i.e., a BS intends to transmit a sync signal or a DL control channel, the BS may perform a channel access procedure in a scheme of the type 2 and transmit a DL signal.

In this case, a scheme of the channel access procedure may be determined according to the length of a signal to be transmitted in the unlicensed band or the length of a period of time or an interval that occupies and uses the unlicensed band. In general, the channel access procedure in a scheme of the type 1 may be performed for a longer period of time than in a scheme of the type 2. Accordingly, when the communication device intends to transmit a signal for a short period of time or a period of time equal to or less than a reference time (e.g., X ms or Y symbols), the channel access procedure may be performed in a scheme of the type 2. On the other hand, when the communication device intends to transmit a signal for a long period of time or a period of time equal to or longer than the reference time (e.g., X ms or Y symbols), the channel access procedure may be performed in a scheme of the type 1. In other words, the channel access procedure may be performed in a different scheme depending on a use time of the unlicensed band.

When the transmitting apparatus performs a channel access procedure in a scheme of the type 1 according to at least one of the aforementioned references, the transmitting apparatus that intends to transmit a signal in the unlicensed band may determine a channel access priority class according to quality of service (QOS) class identifier (QCI) of the signal to be transmitted in the unlicensed band, and perform the channel access procedure using at least one of setting values predefined as in the following Table 4 for the determined channel access priority class. Table 4 represents mapping relations between the channel access priority class and the QCI. The mapping relations between the channel access priority class and the QCI as in Table 4 are taken as an example without being limited thereto.

For example, QCI 1, 2, and 4 refer to QCI values for services such as Conversational Voice, Conversational Video (Live Streaming), Non-Conversational Video (Buffered Streaming) When a signal for a service that does not match a QCI in Table 4 is to be transmitted in an unlicensed band, the transmitting apparatus may select a QCI closest to the service from among QCIs in Table 4 and select a corresponding channel access priority class.

TABLE 4

| Channel Access Priority | QCI |
|---|---|
| 1 | 1, 3, 5, 65, 66, 69, 70 |
| 2 | 2, 7 |
| 3 | 4, 6, 8, 9 |
| 4 | — |

In various embodiments of the disclosure, parameter values for a channel access priority class (e.g., defer duration according to the determined channel access priority p, a set of contention window values or sizes, CWₚ, minimum and maximum values (CW_{min,p} and CW_{max,p}), and a maximum channel occupancy interval (T_{mcot,p})) may be determined as in Table 5. Table 5 represents parameter values for channel access priority types for DL.

For example, a BS that intends to transmit a DL signal in an unlicensed band may perform a channel access procedure for the unlicensed band for a minimum time T_{f}+mₚ*Tₛ₁ (e.g., defer duration). When the BS intends to perform a channel access procedure with a channel access priority class 3 (p=3), the size of T_{f}+mₚ*Tₛ₁, which is a size of the defer duration required to perform the channel access procedure, may be set using mₚ₌3. In this case, T_{f} has a value fixed to 16 μs, during which first Tₛ₁ time needs to be in an idle state, and for the remaining time (T_{f}−Tₛ₁) after Tₛ₁, the BS may not perform the channel access procedure. Even when the BS performs the channel access procedure for the remaining time (T_{f}−Tₛ₁), the result of the channel access procedure may not be used. In other words, T_{f}−Tₛ₁ is time for which the BS defers performing the channel access procedure.

When it is determined that the unlicensed band is in the idle state for the whole time mₚ*Tₛ₁, N may be N−1 (N=N−1). In this case, N may be selected to be any integer value from among values between 0 and a value in a contention window at a time to perform the channel access procedure. For the channel access priority class 3, a minimum contention window value and a maximum contention window value are 15 and 63, respectively. When an unlicensed band is determined to be in an idle state in the defer duration and additional duration during which to perform a channel access procedure, the BS may transmit a signal in the unlicensed band for the time T_{mcot,p} (e.g., 8 ms). Although the DL channel access priority class is focused in the disclosure for convenience of explanation, the channel access priority class in Table 5 may be equally used for UL or a separate channel access priority class for UL may be used.

TABLE 5

| Channel | | | | | | |
|---|---|---|---|---|---|---|
| Access | | | | | | |
| Priority | | | | | | allowed |
| Class (p) | mₚ | CW_{min, p} | CW_{max, p} | T_{mcot, p} | | CWₚ sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

An initial contention window value CWₚ is a minimum value CW_{min,p} of the contention window. After selecting a value of N, the BS may perform the channel access procedure during the interval Tₛ₁, and when the unlicensed band is determined to be in an idle state through the channel access procedure performed in the interval Tₛ₁, the BS may change the value of N to be N=N−1 and may transmit a signal for the maximum T_{mcot,p} time (or a maximum occupancy time) in the unlicensed band when N becomes 0 (N=0). When the unlicensed band determined through the channel access procedure is not in the idle state in the time Tₛ₁, the BS may perform the channel access procedure again without changing the value of N.

The amount of the value of the contention window CWₚ may be changed or maintained according to a rate of NACK, Z, among results (ACK/NACK) of reception of DL data transmitted or reported to the BS by terminals in a reference subframe, a reference slot, or a reference transmission time interval (reference TTI), which have received DL data transmitted by using a DL data channel in the reference subframe, the reference slot, or the reference TTI. In this case, the reference subframe, the reference slot, or the reference TTI may be determined as a point in time for the BS to initiate a channel access procedure, a point in time for the BS to select a value of N to perform the channel access procedure, the first subframe, slot, or TTI of the DL signal transmission interval (or MCOT) involved in the most recent transmission of the BS in the unlicensed band immediately before the two points in time, or a start subframe, start slot, or start TTI of the transmission interval. The reference subframe, the reference slot, or the reference TTI may be determined as a point in time for the BS to initiate a channel access procedure, a point in time for the BS to select a value of N to perform the channel access procedure, or from a starting point in time of a channel occupancy interval (or channel occupancy time (COT) involved in the most recent transmission of the BS in the unlicensed band immediately before the two points in time to the first slot that includes a PDSCH in which the PDSCH is transmitted in the entire PDSCH time-frequency resources scheduled by the BS for the terminal through DCI. The PDSCH may be restricted to a unicast PDSCH on which to receive HARQ-ACK information from the terminal, and when the unicast transmission is not present in the reference subframe, reference slot, or reference interval or when there is no PDSCH present transmitted in the entire PDSCH time-frequency resources scheduled through the DCI, the first DL transmission interval of a channel occupancy interval involved in the most recent transmission may all be the reference subframe, reference slot, or reference interval.

A method of allocating a UL/DL resource will now be described. A UL/DL resource that transmits a signal or a channel may be allocated consecutively or inconsecutively, and when a particular resource allocation type is determined, information indicating UL/DL resource allocation is interpreted based on the particular resource allocation type. In the meantime, in a 3GPP standard, a signal and a channel are used separately, but in the disclosure, a UL/DL transmission signal or a UL/DL transmission channel may not be separated but may be interchangeably used, or the UL/DL transmission signal may be used to mean or represent both the UL/DL transmission signal and the UL/DL transmission channel. This is because a scheme of determining a UL/DL resource allocation type or a position to start UL/DL transmission may be commonly applied to both the UL/DL transmission signal and the UL/DL transmission channel In this case, without extra classification or description, a scheme of determining a UL/DL resource allocation type or a position to start UL/DL transmission proposed in the disclosure may be independently applied to each of the UL/DL transmission signal and the UL/DL transmission channel
resource allocation type 0

The resource allocation type 0 scheme is to allocate a resource in resource block groups (RBGs) comprised of P consecutive RBs. The amount of RBGs, P, may be set to one of Configuration 1 and Configuration 2 through e.g., values of PDSCH-Config, RBG-size of PUSCH-Config, etc., and P may be determined based on the information and the size of an activated UL/DL BWP as in Table 6. Table 6 represents a size of P based on a size of a BWP and an RBG setting value. The size of the BWP is the number of PRBs that make up the BWP.

TABLE 6

| Carrier Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The number N_{RBG} of all RBGs that make up a UL/DL BWP N_{BWP} may be determined to be ceiling (NB_{BWP}^{size}+N_{BWP}^{start}mod P)/P), i.e., N_{RBG}=ceiling (N_{BWP}^{size}+N_{BWP}^{start} mod P)/P. A size of the first RBG, RBG₀, is P−N_{BWP}^{start}mod P. When the value of (N_{BWP}^{start}+N_{BWP}^{size}) mod P is greater than 0, a size of the last RBG, RBGₗₐₛₜ, is (N_{BWP}^{start}+N_{BWP}^{size}) mod P, and when the value of (N_{BWP}^{start}+N_{BWP}^{size}) mod P is not greater than 0, the last RBG, RBGₗₐₛₜ, has a size of P. The size of an RBG other than the first and last RBGs is P. In this case, N_{BWP}^{start} refers to a CRB at which the BWP is started relatively from CRB0, which may be understood as a point at which a particular BWP is started in the CRB. N_{BWP}^{size} refers to the number of RBs included in the BWP.

In this case, length (or size or the number of bits) of frequency resource allocation information is equal to N_{RBG}, and the terminal may be configured or scheduled in RBGs with a resource in which UL/DL transmission is configured or scheduled for each RBG through a bitmap comprised of N_{RBG} bits. For example, the terminal may determine that an RBG region set to 1 in the bitmap is a resource allocated for UL/DL transmission or reception, and that an RBG region set to 0 is not a resource allocated for UL/DL transmission or reception. The RBG bitmap is lined up and mapped sequentially (in ascending order) on the frequency axis. In this way, consecutive or inconsecutive RBGs may be allocated for UL transmission.
resource allocation type 1

The resource allocation type 1 scheme is to allocate consecutive frequency resources in an activated UL/DL BWP. Frequency resource allocation information of the resource allocation type 1 scheme may be indicated to a terminal through a resource indication value (RIV). The length (or size or the number of bits) of frequency resource allocation information is equal to ceiling (log₃ (N_{BWP}(N_{BWP}+1)/2). The RIV indicates a starting RB (RBₛₜₐᵣₜ) for frequency resource allocation and L consecutively allocated RBs (L_{RBs}).

$$if ( {L}_{RBs} - 1 ) \leq ⌊ \frac{{N}_{BWP}}{2} ⌋ then RIV = {N}_{BWP} ( {L}_{RBs} - 1 ) + {RB}_{start} \\ Else , RIV = {N}_{BWP} ( {N}_{BWP} - {L}_{RBs} + 1 ) + ( {N}_{BWP} - 1 - {RB}_{start} ) \\ where , {L}_{RBs} \geq 1 and shall not exceed {N}_{BWP} - {RB}_{start} \qquad Equation 2$$

where N_{BWP} is a size of an activated UL/DL BWP, which is expressed by the number of PRBs, RBₛₜₐᵣₜ is the first PRB at which UL/DL resource allocation is started, and LRB is the length or the number of consecutive PRBs. In this case, when one of pieces of DCI (UL grant) that configures or schedules UL/DL transmission or reception, e.g., DCI format 0_0, is transmitted in common search space (CSS), initial UL/DL BWP size N_{BWP,0} may be used as N_{BWP}.

Furthermore, for DCI format 0_0 or DCI format 1_0transmitted in a UE-specific common search space (USS), the size or the number of bits of frequency resource allocation information for UL/DL grant is determined based on the size of an initial BWP, N_{initial,BWP}, but when the UL/DL DCI is DCI that schedules another activated BWP (the size of the activated BWP N_{active,BWP}), an RIV value has RBₛₜₐᵣₜ=0, K, 2K, . . . , (N_{initial,BWP}−1)·K and L_{RBs}=K, 2K, . . . , N_{initial,BWP}·K, which may be configured as follows:

K may be a natural number that satisfies

$$if ( {L}_{RBs}^{′} - 1 ) \leq ⌊ \frac{{N}_{initial , BWP}}{2} ⌋ then RIV = {N}_{initial , BWP} ( {L}_{RBs}^{′} - 1 ) + {RB}_{start}^{′}$$

$$Else , RIV = {N}_{initial , BWP} ( {N}_{initial , BWP} - {L}_{RBs}^{′} + 1 ) + ( {N}_{initial , BWP} - 1 - {RB}_{start}^{′} )$$

$$where , {L}_{RBs}^{′} = \frac{{L}_{RBs}}{K} , {RB}_{start}^{′} = \frac{{RB}_{start}}{K} , and where {L}_{RBx}^{′} shall not exceed {N}_{intiiial , BWP} - {RB}_{start}^{′}$$

$$where {N}_{active , BWP} > {N}_{intitial , BWP} , K satisfies K \leq ⌊ {N}_{active , BWP} \text{/} {N}_{initial , BWP} ⌋ ,$$

and may be one of {1, 2, 4, 8} in particular. Otherwise, K=1.
resource allocation type 2

The resource allocation type 2 scheme is to allocate resources such that frequency resources in which to transmit UL/DL signals or channels are distributed in an entire activated UL BWP, in which case a distance or a gap between the allocated frequency resources is the same or equal. With the resource allocation type 2, resources are allocated uniformly across the entire frequency band, so the resource allocation type 2 may be limitedly applied in UL/DL signal and channel transmission with a carrier, cell, or BWP operating in an unlicensed band required to satisfy requirements for power spectral density (PSD) and for frequency allocation such as an occupancy channel bandwidth (OCB) condition.

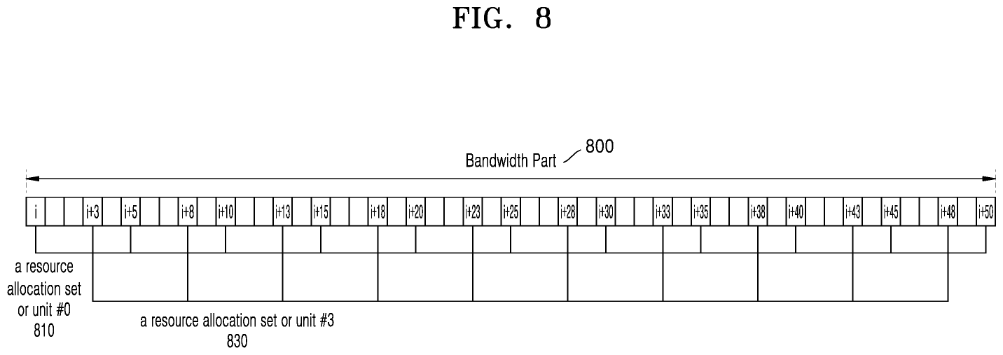

FIG. 8 illustrates a frequency resource allocation scheme, according to an embodiment of the disclosure.

Referring to FIG. 8 for example, the resource allocation type 2 will now be described. In FIG. 8, shown is a case that a terminal is configured to perform UL/DL transmission or reception with a BS in a BWP 800 and scheduled with UL/DL data channel transmission in the resource allocation type 2 scheme, in which case it is assumed that the BWP 800 is comprised of 51 PRBs, without being limited thereto. According to the resource allocation type 2 scheme, 51 PRBs may be comprised of L (L=5 in FIG. 8) resource allocation sets 810, and each resource allocation set may be comprised of

$$N = ⌊ \frac{{N}_{BWP}}{L} ⌋ or N = ⌊ \frac{{N}_{BWP}}{L} ⌋ + 1$$

PRBs. In FIG. 8, the first resource allocation set 810 includes 11 PRBs (#i, #i+5, #i+10, #i+15, . . . , #i+45, #i+50), and the other resource allocation set, for example, a third resource allocation set 830, may include 10 PRBs (#i+3, #i+8, #i+13, #i+18, . . . , #i+48). In other words, the number of PRBs included in a resource allocation set may differ by the size of the BWP or the number of PRBs in the BWP. The terminal may be allocated one or more resource allocation sets configured as described above, and may be allocated consecutive resource allocation sets (e.g., resource allocation sets #0, #1, or #2, #3, #4) through a method similar to the resource allocation type 1 scheme, e.g., based on the RIV value, or allocated consecutive or inconsecutive resource allocation sets in a similar way to the UL resource allocation type 0 scheme, e.g., based on a bitmap.

For example, when the terminal is allocated consecutive resource allocation sets, the terminal may determine in a similar way to the resource allocation type 1, a frequency resource region (or a resource allocation set) allocated with the RIV expressed with a start resource allocation set RBₛₜₐᵣₜ for frequency resource allocation and L consecutive resource allocation sets, in which case the RIV is as follows: where N may be a total number of resource allocation sets.

$$if ( L - 1 ) \leq ⌊ \frac{N}{2} ⌋ then RIV = N ( L - 1 ) + {RB}_{start}$$

$$Else , RIV = N ( N - L + 1 ) + ( N - 1 - {RB}_{start} )$$

For example, RIV=0 indicates the first resource allocation set or the resource allocation set #0, meaning that a resource allocation set comprised of PRBs #i, #i+10, #i+20, . . . , #i+50 of FIG. 8 has been allocated. In this case, the length (or size or the number of bits) of frequency resource allocation information is equal to ceiling (loge (N(N+1)/2).

In another embodiment of the disclosure, when the terminal is allocated consecutive or inconsecutive resource allocation sets using a bitmap, the bitmap is configured in L bits respectively indicating L resource allocation sets in ascending frequency resource order or in ascending order of resource allocation set indexes, and the BS may allocate the resource allocation sets through the bitmap. For example, in FIG. 8, with the bitmap configured in 5 bits, a position of a resource allocation set may be indicated, in which case, bitmap ‘10000’ indicates that the first resource allocation set, i.e., a resource allocation set comprised of PRB #i, #i+10, #i+20, . . . , #i+50 of FIG. 8 is allocated. Bitmap 00010 indicates that the fourth resource allocation set, i.e., a resource allocation set comprised of PRB #i+3, #i+8, #i+13, #i+18, . . . , #i+48 of FIG. 8 is allocated. In this case, the length (or size or the number of bits) of frequency resource allocation information is equal to L.

In a similar way with the frequency, the terminal may be configured with a time resource region of a UL data channel in the following method. The time resource region of the UL data channel may be indicated to the terminal through a start and length indicator value (SLIV). The SLIV is a value determined by a start symbol S for time resource allocation and L symbols consecutively allocated in a slot, which is as follows. When (L−1) is equal to or smaller than 7, the SLIV has a value of 14·(L−1)+S, and when (L−1) is greater than 7, the SLIV has a value of 14·(14−L+1)+(14−1−S). In this case, L has a value greater than 0 and equal to or smaller than 14.

In a general system that uses DFT-s-OFDM based waveforms, the number of frequency resources allocated may be expressed in the product of 2 or a combination of products of 2, 3, or 5, 2ⁿ¹·3ⁿ²·5ⁿ³, n1≥0, n2≥0, n3≥0, for easy implementation of a transceiver and resource allocation efficiency. In other words, in a case that a UL signal or channel is transmitted in DFT-s-OFDM based waveforms as in an NR system (hereinafter, called a case of UL transmission for convenience of explanation), the number of UL transmission frequency resources, i.e., the number of PRBs, Y, needs to be a number that may be represented by products of 2, 3, or 5 (e.g., 10 PRBs). For example, in the NR system, 20 MHz bandwidth with 30 KHz SCS may be comprised of a total of 51 PRBs. In this case, the number of PRBs, 51 is not a value represented by products of 2, 3, or 5, and thus, not available in UL transmission that uses the DFT-s-OFDM based waveforms. Here, the maximum number of PRBs available in UL transmission that uses the DFT-s-OFDM based waveforms is 50. In another example, in the NR system, 20 MHz bandwidth with 15 kHz SCS may be comprised of a total of 106 PRBs. In this case, the number of PRBs, 106 is not a value represented by products of 2, 3, or 5, and thus, not available in UL transmission that uses the DFT-s-OFDM based waveforms. Here, the maximum number of PRBs available in UL transmission that uses the DFT-s-OFDM based waveforms is 106, and 6 PRBs are unavailable as compared to UL transmission in a CP-OFDM scheme, resulting in frequency inefficiency.

Furthermore, in a case of applying a resource allocation scheme 2 as in FIG. 8, the first resource allocation set 810 is comprised of 11 PRBs (#i, #i+5, #i+10, #i+15, , #i+45, #i+50), and the other resource allocation sets are each comprised of 10 PRBs. In this case, the number of PRBs, 11 is not a value represented by a product of 2, 3, or 5, and thus, at least the first resource allocation set 810 is not available in UL transmission that uses the DFT-s-OFDM based waveforms. In addition, for UL transmission that uses the DFT-s-OFDM based waveforms, UL transmission resource allocation including the first resource allocation set 810 is not available. For example, in a case of using three resource allocation sets from the first resource allocation set 810 to the third resource allocation set 830 in a row as UL transmission resources, the number of allocated PRBs are a total of 31, which may not be represented by a product of 2, 3, or 5, so such UL transmission resource allocation may not be performed for the UL transmission that uses the DFT-s-OFDM based waveforms.

Hence, the disclosure provides a method for a terminal to determine a valid resource for UL/DL transmission or reception on an occasion when the terminal uses DFT-s-OFDM based waveforms for UL/DL transmission or reception scheduled through a higher signal or DCI from a BS but a resource allocated for the UL/DL transmission or reception is not appropriate or becomes inefficient in the case of using the DFT-s-OFDM based waveforms, e.g., in a case that an amount of resources allocated for UL/DL transmission or reception is not represented by a combination of products of 2, 3, or 5 (i.e., of 2ⁿ¹·3ⁿ²·5ⁿ³, n1≥0, n2≥0, n3≥0). Specifically, for example, on an occasion when a terminal uses DFT-s-OFDM based waveforms for UL/DL transmission or reception scheduled through a higher signal or DCI from a BS but the number of PRBs allocated for the UL/DL transmission or reception is not represented by a combination of products of 2, 3, or 5 (i.e., 2ⁿ¹·3ⁿ²·5ⁿ³, n1≥0, n2≥0, n3≥0), the disclosure provides a method of allowing a terminal to perform UL/DL transmission or reception, e.g., a method including adjusting or re-evaluating the number of PRBs allocated for the UL/DL transmission or reception to a value represented by a combination of products of 2, 3, or 5 (i.e., 2ⁿ¹·3ⁿ²·5ⁿ³, n1≥0, n2≥0, n3≥0) or a method including determining the number of valid PRBs (e.g., 2ⁿ¹·3ⁿ²·5ⁿ³, n1≥0, n2≥0, n3≥0 ) for the UL/DL transmission or reception among a number of PRBs allocated for the UL/DL transmission or reception and performing UL/DL transmission or reception accordingly. The determining of the valid PRBs for UL/DL transmission or reception is equal to determining valid resources based on a minimum resource unit available for the UL/DL transmission or reception. In other words, when a default unit of UL/DL transmission or reception resources is a subcarrier, the determining is equal to determining the number of valid subcarriers for the UL/DL transmission or reception, and when a default unit of UL/DL transmission or reception resources is a set of subcarriers, the determining is equal to determining the number of valid subcarriers or the number of subcarriers included in the set for the UL/DL transmission or reception. In the disclosure, for convenience of explanation, it is assumed that the default unit of UL/DL transmission or reception resources is a PRB. That is, a method of determining, by a terminal, the number of valid PRBs for UL/DL transmission or reception among UL/DL transmission or reception resources allocated will be described.

The terminal may deliver capability information to the BS about adjustment, re-evaluation, or determination of valid resources (hereinafter, collectively called determination of valid resources) for UL/DL transmission or reception that may be supported or performed. In a case of UL/DL transmission or reception that uses DFT-s-OFDM based waveforms, the BS may schedule UL/DL transmission or reception for the terminal that has transmitted a report that the terminal has or support the capability even when the number of PRBs allocated for the UL/DL transmission or reception is not represented by a combination of products of 2, 3, or 5. In this case, a method of determining valid PRBs for UL/DL transmission or reception, which is performed by the terminal, is as follows:

Method 1: The terminal may determine the number (X≤Y) of the largest PRBs among a number of PRBs that may be represented by among a number of PRBs equal to or smaller than the number Y of PRBs allocated for UL/DL transmission or reception through a higher signal or DCI from the BS to be the number of valid PRBs allocated for the UL/DL transmission or reception. In this case, n1≥0, n2≥0, n3≥0, and X and Y are integers equal to or greater than 1.

Referring to FIG. 8, the method 1 will now be described. For a terminal allocated the resource allocation set #0 810 through a higher signal or DCI from a BS for UL/DL transmission or reception resources, when the UL/DL transmission or reception uses DFT-s-OFDM based waveforms, the terminal may determine that the number of PRBs, X, that may be represented by 2ⁿ¹·3ⁿ²·5ⁿ³ among a number of PRBs equal to or smaller than the number of PRBs (Y=11) of the allocated resource allocation set #0 810, i.e., 10 PRBs, is the number of valid PRBs for the UL/DL transmission or reception. In this case, the terminal may determine that the PRBs other than the number (X) of PRBs, i.e., 10 PRBs, that may be represented by 2ⁿ¹·3ⁿ²·5ⁿ³ among a number of PRBs equal to or smaller than the number of PRBs (Y=11) of the allocated resource allocation set #0 810 are not valid PRBs for the UL/DL transmission or reception. In the following description, for convenience of explanation, determining valid PRBs for UL/DL transmission or reception from among UL/DL transmission or reception resources allocated for the terminal will be described. This is equal to determining PRBs not valid for UL/DL transmission or reception from among UL/DL transmission or reception resources allocated for the terminal, which is obvious to those of ordinary skill in the art. Furthermore, although the resource allocation type 2 was taken as an example in the above description, what was described above may be equally applied to the resource allocation type 0 or 1, or a new resource allocation type.

UL/DL transmission or reception between a BS and a terminal may be correctly performed when the resources determined by the terminal to be UL/DL transmission or reception resources correspond to UL/DL transmission or reception resources determined or intended by the BS. Accordingly, the BS and the terminal need to determine the same number and positions of PRBs determined to be valid in the method 1 from the resource allocation set #0 810 scheduled. Hence, a method of determining not only the number of valid PRBs for UL/DL transmission or reception from among allocated PRBs but also a position of an invalid PRB is required, which may correspond to one or more methods as will be described below. One or a combination of the following methods may be predefined between the BS and the terminal or may be configured by the BS for the terminal in a higher signal. In this case, a terminal that has not been separately configured by the BS with the following method may define or determine in advance that at least one of one or a combination of the following methods is a default method. In this case, one of the following methods may be indicated using at least one of values of frequency resource allocation information in the higher signal or DCI that configures UL/DL transmission or reception, and the terminal may then determine a valid PRB according to the indicated method.

Method A: Method of determining X PRBs in sequence from a PRB with the lowest PRB index toward a higher PRB index among allocated UL/DL transmission or reception resources as valid PRBs for the UL/DL transmission or reception. Referring to FIG. 8, in the method A, a terminal allocated the resource allocation set #0 810 may determine 10 PRBs in sequence from a PRB with the lowest PRB index i toward a higher PRB index, i.e., to PRB index i+45, from among allocated PRBs to be valid PRBs for UL/DL transmission or reception.

Method B: Method of determining X PRBs in sequence from a PRB with the highest PRB index toward a lower PRB index from among allocated UL/DL transmission or reception resources as valid PRBs for the UL/DL transmission or reception. Referring to FIG. 8, in the method B, a terminal allocated the resource allocation set #0 810 may determine 10 PRBs in sequence from a PRB with the highest PRB index i+50 toward a lower PRB index, i.e., to PRB index i+5, from among allocated PRBs to be valid PRBs for UL/DL transmission or reception.

Method C: Method of determining other PRBs than a PRB at a particular PRB position from among allocated UL/DL transmission or reception resources as valid PRBs for the UL/DL transmission or reception. Referring to FIG. 8, in the method C, a terminal allocated the resource allocation set #0 810 may determine the other 10 PRBs than the PRB with PRB index i+25 corresponding to a center position from among allocated PRBs to be valid PRBs for UL/DL transmission or reception. This method may easily satisfy requirements for frequency allocation such as an occupancy channel bandwidth (OCB) requirement in an unlicensed band required to meet the requirements. Sometimes, the methods A and B may not satisfy the OCB requirement due to at least one factor of a frequency band, the number or positions of allocated PRBs.

Method D: A method of sequentially distributing valid PRBs for UL/DL transmission or reception and invalid PRBs for UL/DL transmission or reception among allocated UL/DL transmission or reception resources. In this method, distribution may be made in a direction from a PRB with the highest PRB index toward a lower PRB index or from a PRB with the lowest PRB index toward a higher PRB index. Referring to FIG. 8, in the method D, a terminal allocated the resource allocation set #0 810 may determine that among the allocated PRBs, a PRB with low PRB index i is valid for UL/DL transmission or reception, a PRB with PRB index i+5 is not valid for UL/DL transmission or reception, and PRBs with PRB indexes i+10 to i+50 are valid for UL/DL transmission or reception. In this case, for example, when two PRBs among the resource allocation set #0 810 are determined to be invalid for UL/DL transmission or reception, the PRB with low PRB index i is valid, the PRB with PRB index i+5 is invalid for UL/DL transmission or reception, the PRB with PRB index i+10 is valid for UL/DL transmission or reception, the PRB with PrB index i+15 is invalid for UL/DL transmission or reception, and PRBs with indexes i+20 to i+50 are valid for UL/DL transmission or reception among the allocated PRBs.

Method E: A method by which positions of valid PRBs or invalid PRBs for UL/DL transmission or reception among the allocated UL/DL transmission or reception resources are configured through a higher signal from a BS.

Method 2: A terminal may be configured with a different size of bandwidth or BWP defined in advance or through a higher signal from a BS depending on whether CP-OFDM based or DFT-s-OFDM based waveforms are used. In the disclosure, the size of bandwidth or BWP may be represented by the number of subcarriers or PRBs that make up the bandwidth or the BWP. For example, a different size of bandwidth or BWP depending on whether UL/DL transmission or reception uses CP-OFDM based waveforms or DFT-s-OFDM based waveforms may be configured for the terminal.

In another example, the method 2 is provided to enable the terminal to be configured with a size of bandwidth or BWP defined in advance with the BS or through a higher signal from the BS and to determine a different size of bandwidth or BWP depending on whether the UL/DL transmission or reception uses CP-OFDM based waveforms or DFT-s-OFDM based waveforms. For example, the terminal may determine resource allocation information using the size of the configured bandwidth or BWP when the UL/DL transmission or reception configured or scheduled through a higher signal or DCI from the BS uses CP-OFDM based waveforms, or determine the largest of sizes that may be represented by 2ⁿ¹*3ⁿ²5ⁿ³ among sizes equal to or less than the size of the configured bandwidth or BWP when the UL/DL transmission or reception uses DFT-s-OFMD based waveforms, e.g., the number X of PRBs that may be represented by 2ⁿ¹*3ⁿ²5ⁿ³ among a number of PRBs equal to or smaller than the number Y of PRBs that make up the configured bandwidth or BWP, to be the size of bandwidth or BWP for the UL/DL transmission or reception and use the determination to determine resource allocation information.

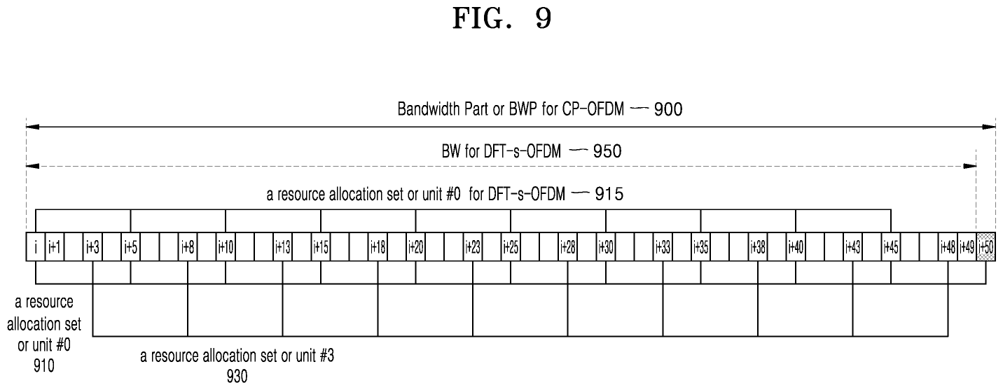

FIG. 9 illustrates a frequency resource allocation scheme, according to an embodiment of the disclosure.

Referring to FIG. 9, the method 2 will now be described. When a terminal configured with a BWP 900 defined in advance with a BS or through a higher signal from a BS uses CP-OFDM based waveforms for UL/DL transmission or reception configured or scheduled through a higher signal or DCI from the BS, the terminal may determine the UL/DL transmission or reception resources using the configured BWP 900 and the size of the BWP 900. In other words, FIG. 9 shows an example of a resource allocation set with resource allocation for UL/DL transmission or reception configured or scheduled through a higher signal or DCI from the BS being in resource allocation type 2, when the terminal is configured by the BS with the size and/or position of the BWP 900 comprised of a total of 51 PRBs from PRB index i to PRB index i+50. According to the method 2, in a case that the UL/DL transmission or reception uses a CP-OFDM scheme, the terminal may determine a resource allocation set according to the resource allocation type 2 based on the configured BWP 900. That is, a resource allocation set #0 910 is comprised of a total of 11 PRBs with PRB indexes i, i+5, i+10, i+45, and i+50. Another resource allocation set, for example, a third resource allocation set 930, may include 10 PRBs (#i+3, #i+8, #i+13, #i+18, . . . , #i+48). In a case that the UL/DL transmission or reception uses DFT-s-OFDM based waveforms, the terminal may determine a resource allocation set according to the resource allocation type 2 by using the largest of sizes that may be represented by 2ⁿ¹*3ⁿ²5ⁿ³ among bandwidth having a size equal to or smaller than the configured BWP 900, e.g., a size or the number of PRBs (X=50) 950 that may be represented by 2ⁿ¹*3ⁿ²5ⁿ³ among a number of PRBs equal to or smaller than the number of PRBs (Y=51) making up the configured bandwidth or the BWP 900. In this case, a resource allocation set #0 915 is comprised of a total of 10 PRBs with PRB indexes i, i+5, i+10, , and i+45.

In the method 2, the terminal may be configured with a size of bandwidth or BWP defined in advance with the BS or through a higher signal from the BS, and determine a different size of bandwidth or BWP depending on whether the UL/DL transmission or reception uses CP-OFDM based waveforms or DFT-s-OFDM based waveforms. In the method 2, a UL/DL frequency resource region transmitted or received using the DFT-s-OFDM based waveforms in the configured BWP may be determined similarly to the method A and method B.

Specifically, similar to the method A, the terminal may determine a maximum number of resources or PRBs that may be represented by 2ⁿ¹*3ⁿ²5ⁿ³ sequentially from a PRB with the lowest PRB index toward a higher PRB index from among the allocated BWP as a UL/DL frequency resource region transmitted or received in DFT-s-OFDM based waveforms. Furthermore, similar to the method B, the terminal may determine a maximum number of resources or PRBs that may be represented by 2ⁿ¹*3ⁿ²5ⁿ³ sequentially from a PRB with the highest PRB index toward a lower PRB index from among the allocated BWP as a UL/DL frequency resource region transmitted or received in DFT-s-OFDM based waveforms. Similarly, the methods C, D, and E may also be applied to the method 2.

In the disclosure, a method by which the terminal determines a waveform used for UL/DL transmission or reception in a system that uses a plurality of UL/DL transmission signal waveforms is described as follows. For convenience of explanation, the method will be described for UL transmission, for example. In this case, it is assumed that the terminal supports a plurality of UL transmission signal waveforms and is defined in advance with the BS or configured through a higher signal to perform UL transmission using all the signal waveforms or some of the plurality of waveforms supported. Furthermore, for convenience of explanation, assume that two of the UL transmission signal waveforms, e.g., first and second UL signal waveforms, use CP-OFDM and DFT-s-OFDM based waveforms, respectively. The terminal is configured with UL signal waveforms through a higher signal in a method as will be described below, or the terminal determines waveforms to be used for UL transmission scheduled through DCI.

In the case of UL transmission configured through a higher signal, when the terminal is configured with waveforms for the UL transmission configured through the higher signal (e.g., transformPrecoder in a configuredGrantConfig message), the terminal performs UL transmission according to the configured waveforms. When the terminal is not configured with waveforms for UL transmission configured through the higher signal, the terminal may perform UL transmission using waveforms configured through an SIB.

In the case of UL transmission scheduled through DCI, when the DCI schedules UL transmission of fallback mode, the terminal uses waveforms configured through the SIB. In a case that the DCI does not schedule the UL transmission of fallback mode or that the DCI schedules UL transmission of non-fallback mode, when UL transmission waveforms are configured according to a higher signal, e.g., a transformPrecoder configuration value in a PUSCH-Config message, the terminal may perform UL transmission using the waveforms configured through the higher signal.

In a case that the DCI does not schedule the UL transmission of fallback mode or that the DCI schedules UL transmission of non-fallback mode, when the terminal is not configured with UL transmission waveforms through a higher signal, the terminal may perform UL transmission using the UL transmission waveforms configured through the SIB.

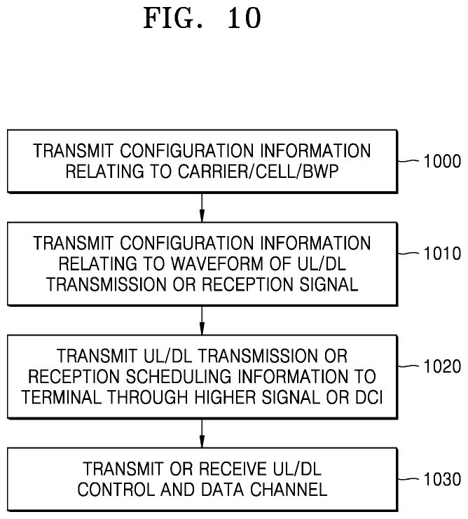

FIG. 10 is a flowchart illustrating an operation of a BS, according to an embodiment of the disclosure.

Although not shown in FIG. 10, a BS may transmit configuration information relating to UL/DL transmission or reception including a maximum number of HARQ processes that may be configured for a terminal, a maximum number of TBs that may be transmitted, etc., to the terminal in a higher signal. Furthermore, although not shown in FIG. 10, the BS may receive capability information including waveforms supported among UL/DL transmission or reception signal waveforms that may be supported by the terminal, e.g., CP-OFDM based waveforms and DFT-s-OFDM based waveforms through a capability information report from the terminal

Referring to FIG. 10, the BS may transmit information relating to UL/DL transmission or reception frequency band and bandwidth, such as a carrier or a cell, a BWP of the carrier or the cell, etc., to the terminal, at operation 1000. The BS may determine a waveform suitable for the UL/DL signal transmission or reception, and configure the UL/DL signal transmission or reception waveform for the terminal based on the determination. In operation 1010, the BS transmits to the terminal the configuration information relating to the waveform of the UL/DL transmission or reception signal. In this case, waveforms for UL signals and DL signals may or may not be the same, and may be separately configured. For example, CP-OFDM based waveforms may be used for DL signal, and both the CP-OFDM based waveforms and the DFT-s-OFDM waveforms may be used for UL signal. Furthermore, the UL/DL signal waveforms may be different depending on the type of a signal or channel to be transmitted or received, the type of transmission, or the type of scheduling DCI. It is also possible to use a signal waveform defined in advance between the BS and the terminal. Subsequently, the BS transmits a higher signal or DCI to the terminal at operation 1020, and receives UL or transmits DL scheduled in the higher signal or DCI in operation 1030. A waveform may be determined according to the DCI format or a scheduling signal or channel, or an indicator indicating the waveform may be included in the DCI.

Furthermore, in a case of determining a resource or bandwidth valid for UL/DL transmission or reception according to a method proposed in the disclosure, it is possible to select a TBS based on the resource determined to be valid, generate a TB based on the TBS, and transmit or receive the TB. In this case, it is also possible to select a TBS based on a frequency resource configured through the higher signal or scheduled through the DCI instead of the resource determined to be valid. The BS may not transmit the resource that is invalid for UL/DL transmission or reception by e.g., puncturing. It is also possible that the BS performs UL/DL transmission or reception with the resource determined as being invalid for the UL/DL transmission or reception.

The aforementioned operations may not be performed sequentially, but may be performed in different order, and even a certain operation may be skipped.

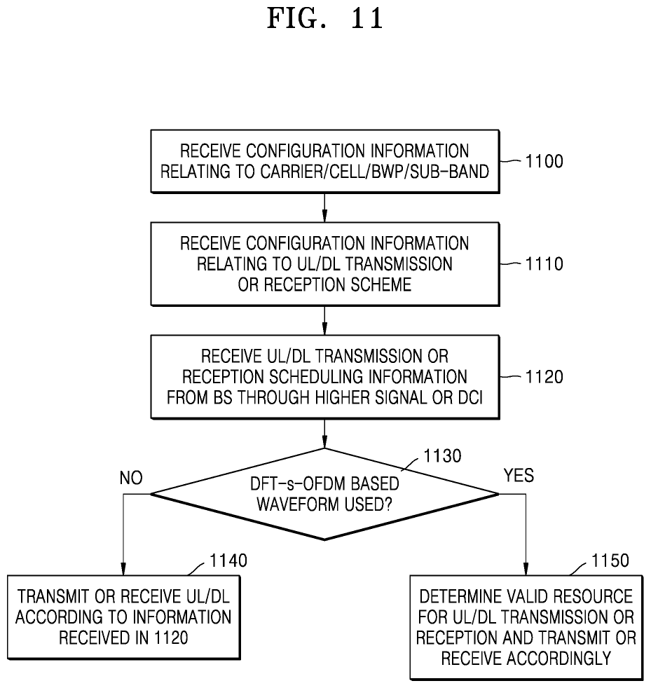

FIG. 11 is a flowchart illustrating an operation of a terminal, according to an embodiment of the disclosure.

Referring to FIG. 11, a terminal may be configured with information relating to UL/DL transmission or reception frequency band and bandwidth, such as a carrier or a cell, a BWP of the carrier or the cell, etc., from a BS, at operation 1100. The configuration may be performed in a higher signal, including at least one piece of information about the size of a BWP, the number of PRBs included in the BWP, or a starting position of the PRBs included in the BWP. Although not shown in FIG. 11, the terminal may transmit capability information such as UL/DL transmission or reception waveforms that may be supported by the terminal through a capability information report to the BS. Furthermore, separately from or together with operation 1100, the terminal may be configured with the maximum number of HARQ processes that may be configured, the maximum number of TBs that may be transmitted, etc., from the BS.

Subsequently, the terminal receives DCI that schedules UL/DL signal or channel transmission or reception from the BS, at operation 1110. In this case, it is also possible that the terminal may be configured with the UL/DL signal or channel transmission or reception through a higher signal. Through the DCI or the higher signal, the terminal determines at least waveforms used for UL/DL transmission or reception and frequency resource information allocated for the UL/DL transmission or reception, at operation 1120. When the waveforms determined to be used for the UL/DL transmission or reception correspond to DFT-s-OFDM based waveforms at operation 1130, the terminal determines a valid resource from the frequency resource information allocated for the UL/DL transmission or reception according to the methods 1 and 2 as described above, and performs the UL/DL transmission or reception with the determined resource, at operation 1150. Specifically, when the waveform for the UL/DL transmission or reception configured through a higher signal or scheduled through DCI is the DFT-s-OFDM based waveform, and an amount of UL/DL transmission or reception resources scheduled through the higher signal or the DCI, e.g., the number of PRBs, has a value that is not represented by 2ⁿ¹*3ⁿ²5ⁿ³, the terminal may determine that a maximum number of resources or PRBs that may be represented by 2ⁿ¹*3ⁿ²5ⁿ³ from among a number of PRBs equal to or smaller than the number of the PRBs configured or scheduled for the UE to be valid for the UL/DL transmission or reception, and perform the UL/DL transmission or reception with the determined resources. In this case, positions of the valid resources or PRB indexes may be determined by one of the methods 1, 2, and A to E or a combination of the methods. When the waveforms determined to be used for the UL/DL transmission or reception do not correspond to DFT-s-OFDM based waveforms at operation 1130, the terminal transmits or receives in operation 1140 the UL/DL transmission or reception according to the information received in operation 1120.

Furthermore, in a case of determining a resource or bandwidth valid for UL/DL transmission or reception according to a method proposed in the disclosure, it is possible to select a TBS based on the resource determined to be valid, generate a TB based on the TBS, and transmit or receive the TB. In this case, it is also possible to select a TBS based on a frequency resource configured through the higher signal or scheduled through the DCI instead of the resource determined to be valid. The terminal may not transmit the resource that is invalid for UL/DL transmission or reception by e.g., puncturing, and may also perform UL/DL transmission with the resource determined as being invalid for the UL/DL transmission or reception.

The aforementioned operations may not be performed sequentially, but may be performed in different order, and even a certain operation may be skipped.

In the disclosure, the expression like ‘equal to or greater (larger) than’ or ‘equal to or smaller (less) than’ is used to determine whether a particular condition (or criterion) is fulfilled, but the expression may not exclude meaning of ‘exceeding’ or ‘smaller (less) than’ A condition written with ‘equal to or greater (larger) than’ may be replaced with ‘exceeding’, a condition with ‘equal to or smaller (less) than’ may be replaced with ‘smaller (less) than’, and a condition with ‘equal to or greater (larger) than˜and smaller (less) than’ may be replaced with ‘exceeding˜and equal to or smaller (less) than˜’.

Methods according to the claims of the disclosure or the embodiments described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. Each of the memories may be provided in the plural.

The program may also be stored in an attachable storage device that may be accessed over a communication network including the Internet, an intranet, a LAN, a wide LAN (WLAN), or a storage area network (SAN), or a combination thereof The storage device may be connected to an apparatus performing the embodiments of the disclosure through an external port. Furthermore, an extra storage device in the communication network may access a device that performs the embodiments of the disclosure.

An apparatus and method according to various embodiments of the disclosure may enable a BS and a terminal to perform more efficient communication by providing a method of allocating frequency resources for signal or channel transmission.

While the disclosure has been shown and described with reference to certain various embodiments thereof, it will be understood by those skilled in the art that various changes in form and details may be made therein without departing from the spirit and scope of the disclosure as defined by the appended claims and their equivalents. Thus, it will be apparent to those of ordinary skill in the art that the disclosure is not limited to the embodiments of the disclosure, which have been provided only for illustrative purposes. Furthermore, the embodiments may be operated by being combined with one another when necessary. For example, parts of the methods proposed in the disclosure may be combined to operate the BS and the terminal Although the embodiments of the disclosure are proposed based on 5G or NR systems, modifications to the embodiments of the disclosure, which do not deviate from the scope of the disclosure, may be applicable to other systems such as an LTE system, an LTE-A system, an LTE-A-Pro system, etc.

What is claimed is:

1. A method, performed by a user equipment (UE), in a wireless communication system, the method comprising:
receiving information on a number of physical resource blocks (PRBs);
determining a valid number of PRBs based on the information in case that a transform precoding is configured; and
transmitting a physical uplink shared channel (PUSCH) based on the valid number of PRBs,
wherein, in case that the number of PRBs based on the information does not satisfy a pre-defined rule associated with the transform precoding, the valid number of PRBs corresponds to a largest integer satisfying the pre-defined rule associated with the transform precoding which is not greater than the number of PRBs based on the information.

2. The method of claim 1, wherein the pre-defined rule associated with the transform precoding requires that the valid number of PRBs corresponds to a form of 2ⁿ¹*3ⁿ²5ⁿ³.

3. The method of claim 1, wherein the information is obtained from a higher layer signaling or downlink control information (DCI).

4. The method of claim 1, wherein the PUSCH is transmitted on the valid number of PRBs in sequence from a lowest-indexed PRB amongst the number of PRBs based on the information.

5. The method of claim 1, further comprising determining at least one valid PRB other than a PRB at a predetermined position from among the number of PRBs based on the information.

6. A user equipment (UE) in a wireless communication system, the UE comprising:
a transceiver; and
at least one processor connected with the transceiver and configured to:
receive information on a number of physical resource blocks (PRBs),
determine a valid number of PRBs based on the information when a transform precoding is configured, and
transmit a physical uplink shared channel (PUSCH), based on the valid number of PRBs,
wherein, in case that the number of PRBs based on the information does not satisfy a pre-defined rule associated with the transform precoding, the valid number of PRBs corresponds to a largest integer satisfying the pre-defined rule associated with the transform precoding which is not greater than the number of PRBs based on the information.

7. The UE of claim 6, wherein the pre-defined rule associated with the transform precoding requires that the valid number of PRBs corresponds to a form of 2ⁿ¹*3ⁿ²5ⁿ³.

8. The UE of claim 6, wherein the information is obtained from a higher layer signaling or downlink control information (DCI).

9. The UE of claim 6, wherein the PUSCH is transmitted on the valid number of PRBs in sequence from a lowest-indexed PRB amongst the number of PRBs based on the information.

10. The UE of claim 6, wherein the at least one processor is further configured to determine at least one valid PRB other than a PRB at a predetermined position from among the number of PRBs based on the information.

11. A method, performed by a base station, in a wireless communication system, the method comprising:
transmitting information on a number of physical resource blocks (PRBs), and wherein a valid number of PRBs is determined based on the information, in case that a transform precoding is configured; and
receiving a physical uplink shared channel (PUSCH) based on the valid number of PRBs,
wherein, in case that the number of PRBs based on the information does not satisfy a pre-defined rule associated with the transform precoding, the valid number of PRBs corresponds to a largest integer satisfying the pre-defined rule associated with the transform precoding which is not greater than the number of PRBs based on the information.

12. The method of claim 11, wherein the pre-defined rule associated with the transform precoding requires that the valid number of PRBs corresponds to a form of 2ⁿ¹*3ⁿ²5ⁿ³.

13. The method of claim 11, wherein the information is transmitted by a higher layer signaling or downlink control information (DCI).

14. The method of claim 11, wherein the PUSCH is received on the valid number of PRBs in sequence from a lowest-indexed PRB amongst the number of PRBs based on the information.

15. The method of claim 11, wherein at least one valid PRB is determined other than a PRB at a predetermined position from among the number of PRBs based on the information.

16. A base station in a wireless communication system, the base station comprising:
a transceiver; and
at least one processor connected with the transceiver and configured to:
transmit information on a number of physical resource blocks (PRBs), and wherein a valid number of PRBs is determined based on the information, in case that a transform precoding is configured; and
receive a physical uplink shared channel (PUSCH), based on the valid number of PRBs,
wherein, in case that the number of PRBs based on the information does not satisfy a pre-defined rule associated with the transform precoding, the valid number of PRBs corresponds to a largest integer satisfying the pre-defined rule associated with the transform precoding which is not greater than the number of PRBs based on the information.

17. The base station of claim 16, wherein the pre-defined rule associated with the transform precoding requires that the valid number of PRBs corresponds to a form of 2ⁿ¹*3ⁿ²5ⁿ³.

18. The base station of claim 16, wherein the information is transmitted by a higher layer signaling or downlink control information (DCI).

19. The base station of claim 17, wherein the PUSCH is received on the valid number of PRBs in sequence from a lowest-indexed PRB amongst the number of PRBs based on the information.

20. The base station of claim 17, wherein at least one valid PRB is determined other than a PRB at a predetermined position from among the number of PRBs based on the information.
